(19) United States
(12) Patent Application Publication
(10) Pub. No.: US 2024/0352286 A1
(43) Pub. Date: Oct. 24, 2024

(54) LAYERED CONSTRUCTIONS WITH REMOVABLE LAYERS

(71) Applicant: Boise State University, Boise, ID (US)

(72) Inventors: Scott PHILLIPS, Boise, ID (US); Rebecca MILLER, Brighton, CO (US); Kyle NOGALES, Nampa, ID (US); Eric L. BARTHOLOMEW, Mill Hall, PA (US); Nishad DHOPATKAR, Lock Haven, PA (US)

(21) Appl. No.: 18/574,092

(22) PCT Filed: Jul. 1, 2022
(86) PCT No.: PCT/IB2022/056160

§ 371 Date: Dec. 26, 2023

Related U.S. Application Data
(60) Provisional application No. 63/217,951, filed on Jul. 2, 2021.
(60) Provisional application No. 63/218,037, filed on Jul. 2, 2021.

(51) Int. Cl. C09J 7/40; C08J 11/04; C09J 7/38; C09J 9/00; C09J 159/00

(52) U.S. Cl. CPC C09J 7/401; C08J 11/04; C09J 7/38; C09J 9/00; C09J 159/00; C08J 2359/00; C09J 2301/302; C09J 2459/005

(57) ABSTRACT

Layered constructions, such as those used in pressure sensitive adhesive constructions and release liner constructions, are disclosed having a functional layer that is capable of removal. Methods of utilizing the layered constructions are also disclosed.

### CROSS-REFERENCE TO RELATED APPLICATIONS

This application claims priority under 35 U.S.C § 119(e) to U.S. Provisional Application No. 63/217,951, filed on Jul. 2, 2021 and U.S. Provisional Application No. 63/218,037 filed on filed on Jul. 2, 2021, both of which are incorporated herein in their entirety.

### FIELD

The present invention generally relates to layered constructions. More particularly, the invention relates to layered constructions, such as those used in pressure sensitive adhesive constructions, and to methods of using the layered constructions.

### BACKGROUND

Packaging is generally marked with information and/or decoration. In some cases, the information and/or decoration is provided in the form of a label, which is generally a multilayered construction containing a facestock (such as paper, polymeric film, fabric, or metallized foil) coated on one side with an adhesive and printed on the opposite side with printed indicia. Before the label is applied it may optionally have a release liner that protects the adhesive. Moreover, the label may have a topcoat to enhance printing. While this construction works well for the purpose of providing information and/or decoration, it poses a problem when the item to which the label is applied is to be disposed through reuse or recycling. For example, the label should ideally be easily removable for purposes of recycling of the underlying article, such as a single-use plastic bottle. Furthermore, it would be desirable to either enable recycling of the release liner or eliminate the release liner in entirety to avoid the material in the waste stream.

Thus, what is needed is packaging, including labeling, that not only serves its packaging function (i.e., hold, protect, handle, deliver, and/or present the goods to which it is associated or affixed), but also can be removed to enable elimination of material and/or recycling, reuse, composting, providing a biodegradable form, and/or proper disposal of the material. The invention is directed to these, as well as other important needs.

### SUMMARY

The present invention relates to layered constructions, such as those used in pressure sensitive adhesive constructions, release liner constructions, printed facestock constructions, and the like, where at least one of the layers can be removed upon activation, reacts by or with a non-ambient stimulus, or responds to a non-ambient stimulus, and to methods of using the layered constructions.

Accordingly, an aspect of the invention is directed to a layered construction, including: a first layer including a first side and a second side; and a functional layer applied on a portion of the first side of the first layer or the second side of the first layer; wherein the functional layer includes a stimuli-responsive polymer.

In many embodiments, the stimuli-responsive polymer reacts to at least one specific, non-ambient, stimuli selected from the group consisting of base, acid, oxidizing agent, reducing agent, non-ionizing radiation, ultrasound, acid derived from a photoacid, ultraviolet light, infrared light, visible light, heat, and combinations thereof. The stimuli-responsive polymer may be a polymer selected from the group consisting of poly(aldehyde), poly(olefin sulfone), poly(cyanoacrylate), poly(glyoxylate), poly(glyoxamide), poly(isocyanate), poly(quinone methide), poly(benzyl ether), poly(carboxy pyrrole), poly(dialdehyde), poly(dithiothreoitol), poly(benzyl carbamate), copolymers thereof, cyclic polymers thereof, or any combination thereof.

In many embodiments, the layered construction further includes a second layer including a first side and a second side; wherein the second layer is applied to the first side of the functional layer; and wherein the functional layer applied to the first side of the first layer. In many embodiments, the first layer is a base layer; the second layer is a release coating; and the stimuli-responsive polymer includes the polymerized residues of Formula I:

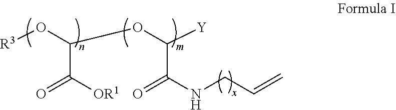

wherein: m=0-1000 units; n=0-1000 units; x=1-15; Y=—CH₃, —CH₂R², —CH(R²)₂, —CH(R²)₃, or —OR²; R¹=each, independently, H, (C₁-C₈)alkyl, allyl, alkynyl, furfuryl, or N-methylmaleimide; R²=each, independently, H, (C₁-C₈)alkyl or allyl; and R³=methyl, allyl, 1-propynyl, benzyl, triphenyl methyl, or triphenylacetoxy; wherein the m and n units form a random copolymer; or a crosslinked derivative of Formula I.

In many embodiments, the layered construction further includes a second layer including a first side and a second side; wherein the second layer is applied to the second side of the first layer; and wherein the functional layer is located on the first side of the first layer; wherein the first layer is an adhesive layer; wherein the second layer is a facestock; and wherein the stimuli-responsive polymer includes the polymerized residues of Formula II:

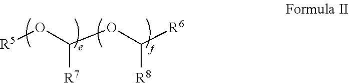

wherein: e=1-1000 units; f=0-1000 units; g=1-15; X=each, independently, O or NH; R⁵=each, independently, H, (C₁-C₇)alkyl, allyl, 1-propynyl,

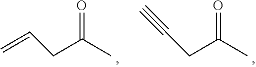

benzyl, triphenylmethyl,

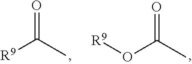

or R¹⁰ (wherein optionally at least one of R⁵ and R⁶=R¹⁰); R⁶=each, independently, (C₁-C₈)alkyl, phenyl, benzyl,

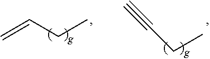

or —X—R¹¹; and R⁷=each, independently, (C₁-C₂₀)alkyl,

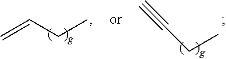

R⁸=each, independently, (C₁-C₁₅)alkyl, phenyl, benzyl, allyl, or 1-propynyl; R⁹=each, independently, (C₁-C₁₅)alkyl, phenyl, benzyl, allyl, or 1-propynyl; R¹⁰=detection unit that cleaves in response to a specific applied stimulus; and R¹¹=each, independently, (C₁-C₇)alkyl, phenyl, benzyl,

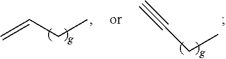

wherein e and f units form a random or block copolymer; or a cyclic derivative or crosslinked derivative of Formula II.

In many embodiments, the first layer is a facestock; wherein the functional layer is located on the first side of the first layer; and wherein the stimuli-responsive polymer includes the polymerized residues of Formula IIIA or Formula IIIB, wherein Formula IIIA has a structure:

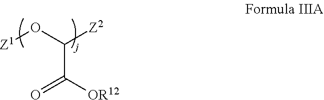

wherein: h=1-15; j=1-1000; Z¹=

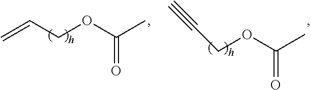

benzyl, triphenyl methyl, allyl, 1-propynyl,

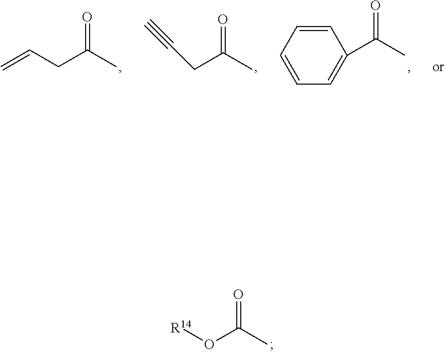

Z²=each, independently, (C₁-C₁₅)alkyl, (C₁-C₁₅)alkyoxy,

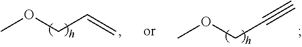

R¹²=each, independently, (C₁-C₇)alkyl; R¹⁴=each, independently, (C₁-C₁₅)alkyl, phenyl, or benzyl; or crosslinked derivative of Formula IIIA; wherein Formula IIIB has a structure:

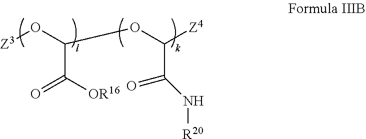

wherein: k=1-1000 units; l=0-1000 units; p=each, independently, 1-15; Z³=

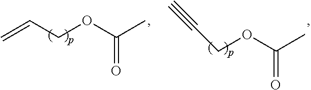

or R¹⁵; Z⁴=methyl, —C(R¹⁹)₂—R¹⁷, or O—R¹⁷; R¹⁵=each, independently, (C₁-C₇)alkyl benzyl, triphenyl methyl, allyl, 1-propynyl,

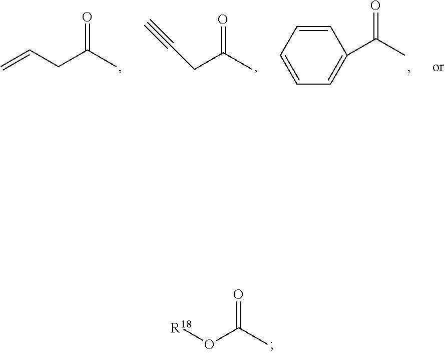

R¹⁶=each, independently, (C₁-C₈)alkyl; R¹⁷=each, independently, (C₁-C₈)alkyl; R¹⁸=each, independently, (C₁-C₁₅)alkyl, phenyl, or benzyl; R¹⁹=each, independently, H or (C₁-C₈)alkyl; R=each, independently,

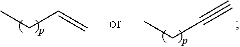

wherein k and l units form a random copolymer; or crosslinked derivative of Formula IIIB. In many embodiments, the first layer is a facestock; wherein the functional layer is a printable top coat; and wherein the stimuli-responsive polymer includes the polymerized residues of Formula I:

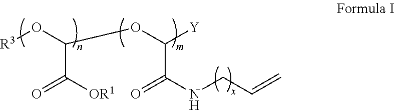

wherein: m=0-1000 units; n=0-1000 units; x=1-15; Y=—CH₃, —CH₂R², —CH(R²)₂, —CH(R²)₃, or —OR²; R¹=each, independently, H, (C₁-C₈)alkyl, allyl, alkynyl, furfuryl, or N-methylmaleimide; R²=each, independently, H, (C₁-C₈)alkyl or allyl; and R³=methyl, allyl, 1-propynyl, benzyl, triphenyl methyl, or triphenylacetoxy; wherein the m and n units form a random copolymer; or a crosslinked derivative of Formula I.

In many embodiments, the first layer is a facestock; wherein the functional layer includes an ink; and wherein the stimuli-responsive polymer includes the polymerized residues of at least one of Formula I, a crosslinked derivative of Formula I, Formula II, a cyclic derivative of Formula II, a crosslinked derivative Formula II, Formula IIIA, a crosslinked derivative of Formula IIIA, a crosslinked derivative of Formula IIIA, Formula IIIB, and a crosslinked derivative of Formula IIIB,

wherein Formula I has a structure:

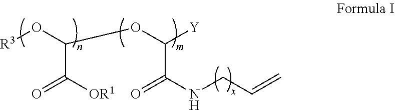

wherein: m=0-1000 units; n=0-1000 units; x=1-15; Y=—CH₃, —CH₂R², —CH(R²)₂, —CH(R²)₃, or —OR²; R¹=each, independently, H, (C₁-C₈)alkyl, allyl, alkynyl, furfuryl, or N-methylmaleimide; R²=each, independently, H, (C₁-C₈)alkyl or allyl; and R³=methyl, allyl, 1-propynyl, benzyl, triphenyl methyl, or triphenylacetoxy; wherein the m and n units form a random copolymer; wherein Formula II has a structure:

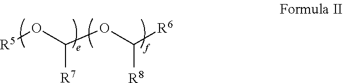

wherein: e=1-1000 units; f=0-1000 units; g=1-15; X=each, independently, O or S; R⁵=each, independently, H, (C₁-C₇)alkyl, allyl, 1-propynyl,

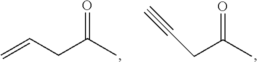

benzyl, triphenylmethyl,

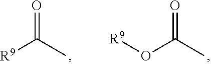

or R¹⁰ (wherein optionally at least one of R⁵ and R⁶=R¹⁰); R⁶=each, independently, (C₁-C₈)alkyl, phenyl, benzyl,

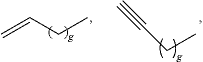

or —X—R¹¹; and R⁷=each, independently, (C₁-C₂₀)alkyl,

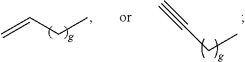

R⁸=each, independently, (C₁-C₁₅)alkyl, phenyl, benzyl, allyl, or 1-propynyl; R⁹=each, independently, (C₁-C₁₅)alkyl, phenyl, benzyl, allyl, or 1-propynyl; R¹⁰=detection unit that cleaves in response to a specific applied stimulus; and R¹¹=each, independently, (C₁-C₇)alkyl, phenyl, benzyl,

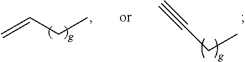

wherein e and f units form a random or block copolymer; wherein Formula IIIA has a structure:

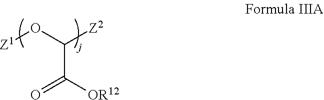

wherein: h=1-15; j=1-1000; Z¹=

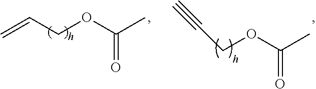

benzyl, triphenyl methyl, allyl, 1-propynyl,

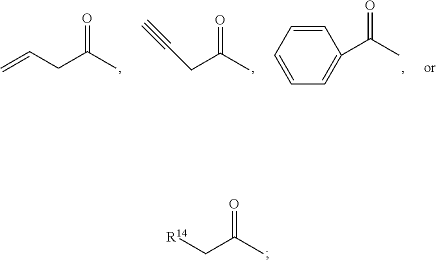

Z²=each, independently, (C₁-C₁₅)alkyl, (C₁-C₁₅)alkyoxy,

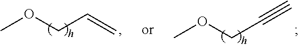

R¹²=each, independently, (C₁-C₇)alkyl; R¹⁴=each, independently, (C₁-C₁₅)alkyl, phenyl, or benzyl; and wherein Formula IIIB has a structure:

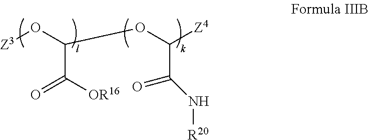

wherein: k=1-1000 units; l=0-1000 units; p=each, independently, 1-15; Z³=

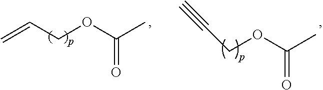

or R¹⁵; Z⁴=methyl, —C(R¹⁹)₂—R¹⁷, or O—R¹⁷; R¹⁵=each, independently, (C₁-C₇)alkyl benzyl, triphenyl methyl, allyl, 1-propynyl,

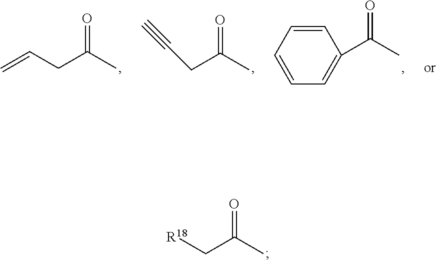

R¹⁶=each, independently, (C₁-C₈)alkyl; R¹⁷=each, independently, (C₁-C₈)alkyl; R¹⁸=each, independently, (C₁-C₁₅)alkyl, phenyl, or benzyl; R¹⁹=each, independently, H or (C₁-C₈)alkyl;
R²⁰=each, independently,

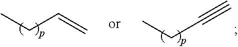

wherein k and l units form a random copolymer.

Another aspect of the invention is directed to methods of using the layered construction. Many embodiments, provide a method is a method of recycling a coated release liner, including: providing a layered construction as described hereinabove, wherein the first layer is a base layer; and wherein the second layer is a release coating; and exposing the layered construction to a non-ambient stimulus for a time sufficient to separate the first layer from the second layer.

Many embodiments provide a method of providing a linerless adhesive article, including: providing a layered construction as described hereinabove; wherein the first layer is an adhesive layer; and wherein the second layer is a facestock; and exposing the layered construction to a non-ambient stimulus for a time sufficient to remove the functional layer from the first layer to reveal the adhesive layer.

Many embodiments provide a method of recycling, composting, and/or providing a degradable adhesive article, including: providing a layered construction as described hereinabove; wherein the first layer is a facestock layer; and wherein the functional layer functions as a pressure sensitive adhesive; and exposing the layered construction to a non-ambient stimulus for a time sufficient to depolymerize the functional layer.

Many embodiments provide a method of recycling a printed facestock, including: providing the layered construction as described hereinabove; wherein the first layer is a facestock layer; and wherein the functional layer is a printable top coat; wherein the layered construction further includes printed indicia on the top coat; and exposing the layered construction to a non-ambient stimulus for a time sufficient to depolymerize the functional layer.

Many embodiments provide a method of recycling a printed facestock, including: providing the layered construction as described hereinabove; wherein the first layer is a facestock; wherein the functional layer is an ink; and exposing the layered construction to a non-ambient stimulus for a time sufficient to depolymerize the functional layer.

The summary of the invention is provided as a general introduction to some of the embodiments of the invention, and is not intended to be limiting. Additional example embodiments, including variations and alternative configurations, of the invention are provided herein.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a cross-section of one illustrative embodiment of the layered construction of the invention, where the layered construction is a release liner.

FIG. 2 is a cross-section of one illustrative embodiment of the layered construction of the invention, where the layered construction is a linerless pressure sensitive adhesive construction.

FIG. 3 is a cross-section of one illustrative embodiment of the layered construction of the invention, where the layered construction has a depolymerizable pressure sensitive adhesive layer.

FIG. 4 is a cross-section of one illustrative embodiment of the layered construction of the invention, where the layered construction has a depolymerizable functional layer, and a depolymerizable pressure sensitive adhesive functional layer.

FIG. 5 is a cross-section of one illustrative embodiment of the layered construction of the invention, where the layered construction has a depolymerizable functional layer, a depolymerizable pressure sensitive adhesive functional layer, and a depolymerizable masking functional layer.

FIG. 6 is a cross-section of one illustrative embodiment of the layered construction of the invention, where the layered construction has a removable printable top coat layer.

FIG. 7 is a cross-section of one illustrative embodiment of the layered construction of the invention, where the layered construction has a removable ink layer.

FIG. 8 is a cross-section of one illustrative embodiment of a layered construction of the invention including multiple functional layers.

FIG. 9 is a cross-section of one illustrative embodiment of a layered construction of the invention including multiple functional layers.

FIG. 10 is a cross-section of one illustrative embodiment of a layered construction of the invention including multiple functional layers.

FIG. 11 is a cross-section of one illustrative embodiment of a layered construction of the invention including multiple functional layers.

FIG. 12 is a graphic representation of water contact angle (WCA) testing results for constructions, before and after caustic treatment.

FIG. 13 is a graphic representation of FTIR (Fourier-transform infrared spectroscopy) spectra for constructions, before and after caustic treatment.

FIG. 14 is a graphic representation of adhesion testing results for constructions.

FIG. 15A is an image of constructions before caustic wash was performed.

FIG. 15B shows an image of the constructions of FIG. 15 A after caustic wash was performed.

FIG. 16 is a representation of FTIR spectra for constructions, before and after caustic treatment.

FIG. 17 is a representation of FTIR spectra for constructions, before and after caustic treatment.

FIG. 18 is a representation of FTIR spectra for constructions, before and after caustic treatment.

### DETAILED DESCRIPTION OF THE ILLUSTRATED EMBODIMENTS

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended to be open-ended, and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one,” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, the term “alkyl” refers to a moiety containing predominantly fully-saturated hydrocarbons that are linear, branched, or cyclic, where the number of carbon atoms permit branching or cyclization.

As used herein, the prefix “(meth)acryl-” refers to both “methacryl-” and “acryl-”, such as in “(meth)acrylic” (meaning both methacrylic and acrylic), “(meth)acrylate” (meaning both methacrylate and acrylate), and “(meth)acrylonitrile” (meaning both methacrylonitrile and acrylonitrile). The term “(meth)acrylate” refers to monomeric acrylic or methacrylic esters of alcohols. Acrylate and methacrylate monomers are referred to collectively herein as “(meth)acrylate” monomers. Polymers prepared from (meth)acrylate monomers are referred to as (meth)acrylate polymers.

As used herein, the term “acrylate resin” refers to at least one (meth)acrylate polymer or copolymer and may include a blend of different (meth)acrylate polymers and copolymers.

As used herein, the term “polymer” will be understood to include polymers, copolymers (e.g., polymers formed using two or more different monomers), oligomers, and combinations thereof.

The term “copolymer” is used herein to refer to polymers containing copolymerized units of at least two different monomers (i.e., a dipolymer).

As used herein, the term “facestock” means a layer or multiple layers of film material (such as paper, polymeric film, fabric, metallic foil, or combinations thereof) to which printed indicia is or can be added, and which can optionally be corona treated. The facestock has two sides, including a side that is outward facing and that can receive printed indicia (directly or indirectly) and the other side that is inward facing and that can receive an adhesive or other layer. Suitable facestocks include for example, paper, polymeric film, co-extruded films, metallic films, coated versions thereof, recycled content version thereof, or combinations thereof. Representative examples include, without limitation, polyester, polyethylene terephthalate, low-density polyethylene, high-density polyethylene, biaxially-oriented polypropylene, polystyrene, and polyvinyl chloride, and the like. The thickness of the facestock typically ranges from 10 μm to 300 μm. In some embodiments, the facestock has a thickness of 10 μm to 250 μm, 30 μm to 220 μm, 20 μm to 200 μm, 30 μm to 150 μm, 10 μm to 150 μm, 10 μm to 100 μm, 10 μm to 50 μm, or 10 μm to 25 μm. In some embodiments, the facestock is a film having a thickness of 10 μm to 180 μm, 10 μm to 25 μm, or 10 μm to 50 μm, 10 μm to 100 μm, or 10 μor m to 150 μm. In some embodiments, the facestock is a paper having a thickness of 10 μm to about 300 μm, 30 μm to 220 μm, 20 μm to 200 μm, or 30 μm to 150 μm.

As used herein, the term “adhesive layer” means a layer or multiple layers of the same or different pressure sensitive adhesives applied to at least a portion of the surface of another layer of the construction. In many embodiments, the adhesive is applied to at least a portion of the surface of a facestock. The thickness of the adhesive layer typically ranges from 20 μm to at least 125 μm. In some embodiments, the adhesive layer has a thickness of 10 um to 500 um. In some embodiments, the adhesive layer has a thickness of 10 um to 300 um, 10 um to 100 um, or 10 um to 50 um.

As used herein, “pressure sensitive adhesive” or “PSA” refers to a material that may be identified by the Dahlquist criterion, which defines a pressure sensitive adhesive as an adhesive having a one second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Another well-known means of identifying a pressure sensitive adhesive is an adhesive that it is aggressively and permanently tacky at room temperature and firmly adheres to a variety of dissimilar surfaces upon mere contact without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the layered constructions of the invention. Pressure sensitive adhesives are permanently tacky in dry form and can firmly adhere to a substrate with very light pressure. The adhesive requires no activation by solvent, water, or heat to exert sufficient holding power.

As used herein, the term “permanent” as it relates to “pressure sensitive adhesive” means a pressure sensitive adhesive that is not easily removable without total or partial destruction of the layered construction (of which it is a part) or substrate (to which the layered construction is applied). Permanent adhesives present adhesion values greater than 230 N/m, based on FINAT (Féderation Internationale des fabricants et transformateurs d'Adhésifs et Thermocollants sur papiers et autres supports (International Federation of Manufacturers and Converters of Adhesives and Iron-Ons on Paper and Other Supports)) Test Method 1—Peel adhesion (180°) at 300 mm/minute. An example of a permanent adhesive is Fasson® S692N adhesive, available from Avery Dennison Corporation (located in Ohio, USA).

As used herein, the term “removable” as it relates to “pressure sensitive adhesive” means a pressure sensitive adhesive that is removable without destruction of the layered construction (of which it is a part) or substrate (to which the layered construction is applied). Removable adhesives present adhesion values greater than 30 N/m, based on FINAT Test Method 1—Peel adhesion (180°) at 300 mm/minute. Such removable pressure sensitive adhesives have low adhesion to the substrate, allowing for the easy hand removal of the layered construction from the substrate to which it is applied. Removable pressure sensitive adhesives include true removable adhesives, which are chemically designed for removability, and permanent adhesives that are applied at a low coat weight such that they remain removable. An example of a removable adhesive is Fasson® R185 adhesive, available from Avery Dennison Corporation.

As used herein, the term “depolymerize” means to convert from a polymer to at least one of small molecules, short oligomers or monomers. The depolymerization may be complete, substantially complete, incomplete or substantially incomplete. The term “depolymerizable” means able to depolymerize.

As used herein, the phrase “release liner” means film sheet (typically paper such as kraft or glassine, or polymeric film such as PET (polyethylene terephthalate) or polyolefin, usually applied during the manufacturing process, used to prevent a sticky surface from prematurely adhering to a substrate. It is coated on one or both sides with a release agent, which provides a release effect against any type of a sticky material, such as an adhesive or a mastic. The release agent may be applied a coating level of 0.5-3 gsm.

As used herein, the phrase “printed indicia” means any string of alphanumeric or special characters used to convey information (such as name, residence or mailing address, telephone number, prescription number, and the like) and/or provide aesthetic appeal. The indicia may be printed by any suitable means, including printing by hand, typewriter, or conventional printing (such as flexographic printing, offset printing, inkjet printing, laser inkjet printing, videojet printing, thermal transfer, direct printing, gravure printing, and the like).

As used herein, the term “label” means a two-dimensional piece of paper, fabric, plastic, or similar material, configured to be attached to an object and giving information about it and/or decoration to it. The label may be any suitable shape or design, such as, for example, rectangular, square, circular, oval, triangular, multisided and irregular shapes. The label may have edges and corners that are sharp, rounded, or irregular. Labels may be formed from the layered constructions described herein, with optional printed indicia thereon.

As used herein, the phrase “non-ambient stimulus” means a material or condition that is in not in the environment in which the layered construction is conventionally used, but when introduced in the presence of the layered construction, causes some type of response by one or more components in the layered construction.

As used herein, the phrase “polymerized residues” means repeating units as defined by a formula.

As used herein, “gsm” means grams per square meter.

All percentages noted herein are percentages by weight based upon the weight of the composition, unless indicated otherwise.

The invention is directed to layered constructions including a stimuli-responsive polymer that responds to at least one specific, non-ambient stimuli. The stimuli-responsive polymer is present in a functional layer that can reside on another layer, or be sandwiched between different layers. In the absence of a stimuli, the layered construction continues to function according to its intended use. However, when the appropriate non-ambient stimuli is applied, it causes a response of the stimuli-responsive polymer, thereby enabling at least one layer of the layered construction to be removed. Accordingly, the layered constructions may be used in a variety of different applications and methods where it is desirable to remove one or more of the layers, such as, for example, to permit recycling of the layered construction, recovery of the component layers of the construction, exposure of underlying or masked layers of the layered construction, prevention of the necessity of non-essential layers of the layered construction, and the like.

The layered construction includes a first layer, including a first side and an oppositely directed second side. A functional layer is present on at least a portion of the first side of the first layer, or the second side of the first layer. The functional layer includes a stimuli-responsive polymer. The stimuli-responsive polymer reacts to at least one specific, non-ambient stimuli.

Any suitable non-ambient stimuli can be used, as long as it initiates the desired response of the stimuli-responsive polymer. In many embodiments, the non-ambient stimuli is selected from the group of a base, acid, oxidizing agent, reducing agent, non-ionizing radiation, ultrasound, acid derived from a photoacid, ultraviolet light, infrared light, visible light, heat, or any combination thereof. The duration of exposure of the layered construction to the non-ambient stimulus is sufficient to cause the stimuli-responsive polymer in at least one functional layer in the layered construction to depolymerize.

Any suitable stimuli-responsive polymer can be used. In many embodiments, the stimuli-responsive polymer may be a polymer selected from the group of a poly(aldehyde), poly(olefin sulfone), poly(cyanoacrylate), poly(glyoxylate), poly(glyoxamide), poly(isocyanate), poly(quinone methide), poly(benzyl ether), poly(carboxy pyrrole), poly(dialdehyde), poly(dithiothreoitol), poly(benzyl carbamate), copolymers thereof, cyclic polymers thereof, or any combination thereof. In many embodiments, the stimuli-responsive polymer is selected from a poly(glyoxamide) poly(glyoxylate)-poly(glyoxamide) copolymer, poly(glyoxylate), or any combination thereof. In many embodiments, the stimuli-responsive polymer is a poly(glyoxamide). In many embodiments, the stimuli-responsive polymer has at least one terminal alkene, such as for example a poly(glyoxamide) or poly(glyoxamide)-poly(glyoxylate) copolymer having at least one terminal alkene. In many embodiments, at least one of the poly(glyoxamide) and poly(glyoxamide)-poly(glyoxylate) copolymer has at least one terminal alkene, such as for example a poly(allyl glyoxamide) or poly(allyl glyoxamide)-poly(glyoxylate) copolymer. In many embodiments, the stimuli-responsive polymer is selected from a derivative of a poly(glyoxamide), poly(glyoxylate)-poly(glyoxamide) copolymer, poly(glyoxylate), poly(alkyl aldehyde), or any combination thereof. In many embodiments, the stimuli-responsive polymer is a poly(alkyl aldehyde) derivative. In many embodiments, the poly(alkyl aldehyde) derivative includes at least one terminal alkene, such as for example poly(3-butenal).

In many embodiments, the monomer used to make the stimuli-responsive polymer includes at least one of an alkyl aldehyde, halogenated aldehyde, dialdehyde, phthalaldehyde, substituted phthalaldehyde, isocyanate, quinone methide, azaquinone methide, carbamate, cyanoacrylate, dithiothreoitol, variation of dithiothreoitol, glyoxylate, or glyoxamide. In embodiments, the monomer used to make the stimuli-responsive polymer includes at least one carbamate that leads to a poly(benzyl carbamate) or a poly(carboxypyrrole). In some embodiments, the monomer used to make the stimuli-responsive polymer includes at least one of an aniline carbamate and a pyrrole carbamate.

The type and composition of the first layer will depend on the particular construction of the layered construction. In some embodiments, the first layer is a base layer. In some embodiments, the first layer is a base layer selected from paper, polymeric film, fabric, metallic foil, or any combination thereof. In some embodiments, the first layer is a base layer selected from paper, polymeric film, or a combination thereof. In some embodiments, the first layer is a coated paper, such as for example a polyethylene coated paper. In some embodiments, the first layer is a base polymer layer. In many embodiments, the polymeric film is made of PET, BOPP (biaxially-oriented polypropylene), HDPE (high density polyethylene) or any combination thereof. In certain embodiments, the first layer is a facestock layer. In many embodiments, the facestock layer is selected from a paper, polymeric film, fabric, metallic foil, or combinations thereof. In certain embodiments, the first layer is a pressure sensitive adhesive layer. Any suitable pressure sensitive adhesive can be used. In some embodiments, the pressure sensitive adhesive is selected from an emulsion, solvent, warm melt, or hot melt, adhesive. Suitable hot melt adhesives include, for example SIS (styrene-isoprene-styrene block copolymer), SBS (styrene-butadiene-styrene) block copolymer, acrylic, styrenic, polyolefin, polyacetate, polyester, polyamide and polyurethane hot melts, or any combination thereof. In some embodiments, the pressure sensitive adhesive is selected from an acrylic, styrenic, polyurethane, epoxy, polyester, or any combination thereof. paper,

In certain embodiments, the layered construction may further include a second layer including a first side and an oppositely directed second side. The second layer may be located on any suitable location on the layered construction. In certain embodiments, the second layer is situated on the first side of the first layer, and the functional layer is located between the first layer and the second layer. In this configuration, the depolymerization of the functional layer causes the separation of the first layer from the second layer. In certain embodiments, the functional layer is situated on the first side of the first layer, and the second layer is situated on the second side of the first layer. In this configuration, the depolymerization of the functional layer unmasks the underlying first layer.

The type and composition of the second layer will depend on the particular construction of the layered construction. The second layer can be the same as or different from the first layer. In certain embodiments of the layered construction, the first layer and the second layer have dissimilar compositions. In certain embodiments, the first layer and the second layer have the same compositions.

In several embodiments, the layered construction is useful as a recyclable liner. In certain embodiments, the first layer is a base layer, and the layered construction further includes a second layer that is a release coating. The base layer can be made of any suitable material, such as for example, paper, polymeric film, fabric, metallic foil, or combinations thereof. Any suitable polymer can be used in a polymeric film base layer, such as for example PET, BOPP HDPE or a combination thereof. In some embodiments, the base layer is a coated paper, such as for example a polyethylene coated paper. Any suitable release coating can be used. In some embodiments, the release coating is a polydimethyl siloxane (PDMS), silicone, flurosilicone, or fluorinated acrylate coating, or any combination thereof. The functional layer is situated between the base layer and the release coating and is thus adjacent to the release coating and the base layer. The stimuli-responsive polymer in the functional layer may include any suitable polymer. In certain embodiments, the stimuli-responsive polymer includes the polymerized residues of Formula I:

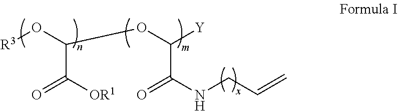

wherein: n=0-1000; m=0-1000; x=1-15; Y=—CH₃, —CH₂R², —CH(R²)₂, or —OR²; R¹=each, independently, H, (C₁-C₈) alkyl, allyl, alkynyl, furfuryl, or N-methylmaleimide; R²=each, independently, H, (C₁-C₈) alkyl or allyl; and R³=methyl, allyl, 1-propynyl, benzyl, triphenyl methyl, or triphenylacetoxy. Further, the m and n units form a random copolymer. In certain embodiments, the stimuli-responsive polymer includes a crosslinked derivative of Formula I. In some embodiments, Formula I is selected from an atactic, isotactic, or syndiotactic polymer, or any combination thereof. In some embodiments, Formula I is selected from an atactic or syndiotactic polymer, or a combination thereof.

In certain embodiments, the base layer may have a thickness of 10 μm to 180 μm. In certain embodiments, the base layer may have a thickness of 10 μm to 180 μm, 10 μm to 25 μm, 10 μm to 50 μm, 10 μm to 100 μm, or 10 μm to 150 μm. In certain embodiments, the functional layer may have a thickness of 10 μm to 180 μm. In certain embodiments, the functional layer may have a thickness of 10 μm to 180 μm, 10 μm to 25 μm, 10 μm to 50 μm, 10 μm to 100 μm, or 10 μm to 150 μm. In certain embodiments, the release coating may have a thickness of 0.5-3 gsm. In certain embodiments, the release coating may have a thickness of 0.5-2 gsm, or 0.5-1 gsm.

In several embodiments, the layered construction is useful as a linerless adhesive construction. Linerless constructions provide a cost savings and sustainability associated with the absence of a release liner. In certain embodiments of the layered construction, the first layer of the layered construction is an adhesive layer that includes a pressure sensitive adhesive. The construction further includes a second layer that has a first side and an oppositely directed second side. The second layer is a facestock that is located on the second side of the first layer. Any suitable facestock can be used, such as for example those described hereinabove. The functional layer is located on the first side of the adhesive layer. The stimuli-responsive polymer in the functional layer includes the polymerized residues of Formula II, where Formula II has the structure:

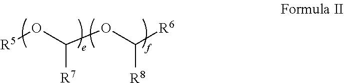

wherein: e=1-1000 units; f=0-1000 units; g=1-15; X=O or NH; R⁵=each, independently, H, (C₁-C₇)alkyl, allyl, 1-propynyl,

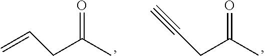

benzyl, triphenylmethyl,

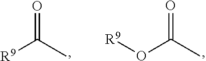

or R¹⁰ (wherein optionally at least one of R⁵ and R⁶=R¹⁰); R⁶=each, independently, (C₁-C₈)alkyl, phenyl, benzyl,

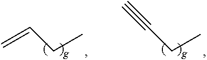

or —X—R¹¹; and R⁷=each, independently, (C₁-C₂₀)alkyl,

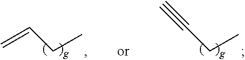

R⁸=each, independently, (C₁-C₁₅)alkyl, phenyl, benzyl, allyl, or 1-propynyl; R⁹=each, independently, (C₁-C₁₅)alkyl, phenyl, benzyl, allyl, or 1-propynyl; R¹⁰=detection unit that cleaves in response to a specific applied stimulus; and R¹¹=each, independently, (C₁-C₇)alkyl, phenyl, benzyl,

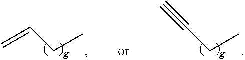

Further, the e and f units form a random or block copolymer. In certain embodiments, the stimuli-responsive polymer includes a cyclic derivative, or crosslinked derivative, of Formula II. In some embodiments, Formula II is selected from an atactic, isotactic or syndiotactic polymer, or any combination thereof. In some embodiments, the adhesive of the first layer of the layered construction is a functional adhesive. The functional adhesive can include a stimuli-responsive ipolymer including the polymerized residues of Formula IIIA or IIIB, each having a structure described herein-below.

As noted hereinabove, depending on its structure, the cleaving group R¹⁰ can react with specific, non-ambient, stimuli, and cleave in response to that specific stimulus. In certain embodiments of the layered construction, the cleaving group R¹⁰ can react with at least on of peroxide, heat, acid, or UV light. In certain embodiments, the cleaving group R¹⁰ has the following structure, that can react with hydroperoxides:

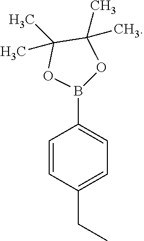 [SMILES: CCc1ccc(B2OC(C)(C)C(C)(C)O2)cc1]

In certain embodiments, the cleaving group R¹⁰ has the following structure that can react with hydroperoxides:

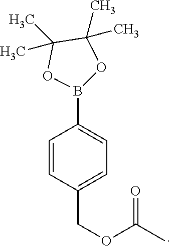 [SMILES: CC(=O)OCc1ccc(B2OC(C)(C)C(C)(C)O2)cc1]

In certain embodiments, the cleaving group R¹⁰ has the structure, —SiR₃^{7a}, that can react with fluoride, wherein: R^{7a}=each, independently, (C₁-C₂₀)alkyl, phenyl, benzyl,

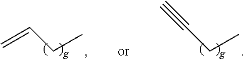

In certain embodiments, the cleaving group R¹⁰ has the following structure that can react with at least one of heat or acid:

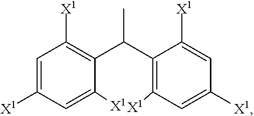

wherein X¹=each, independently, H, (C₁-C₃)alkoxy, or NR^{7b}; and R^{7b}=each, independently, (C₁-C₂)alkyl. In certain embodiments, the cleaving group R¹⁰ has the following structure, that can react with UV light:

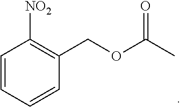

In certain embodiments, the layered construction includes a depolymerizable adhesive layer. The depolymerizable adhesive may be a pressure sensitive adhesive. The first layer, which has a first side and an oppositely directed second face, is a facestock. The facestock may be made of any suitable material, such as those described hereinabove. The PSA adhesive functional layer may be located on the first side of the first layer. In many embodiments, the stimuli-responsive polymer in the functional layer includes the polymerized residues of Formula IIIA or IIIB, where Formula IIIA is:

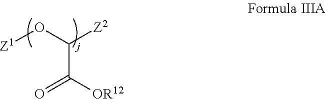

Wherein: h=1-15; j=1-1000; Z¹=

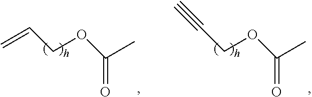

benzyl, triphenyl methyl, allyl, 1-propynyl,

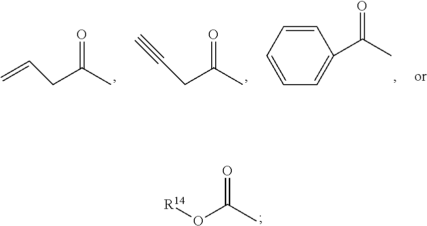

Z²=each, independently, (C₁-C₁₅)alkyl, (C₁-C₁₅)alkyoxy,

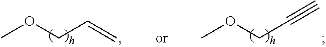

R¹²=each, independently, (C₁-C₇)alkyl; and R¹⁴=each, independently, (C₁-C₁₅)alkyl, phenyl, or benzyl. In some embodiments, the stimuli-responsive polymer includes a crosslinked derivative of Formula IIIA. Formula IIIB is:
or; or

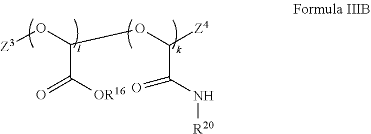

Wherein: k=1-1000 units; l=0-1000 units; p=each, independently, 1-15; Z³=

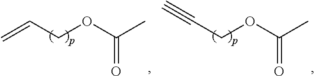

or R¹⁵; Z⁴=methyl, —C(R¹⁹)₂—R¹⁷, or O—R¹⁷; R¹⁵=each, independently, (C₁-C₇)alkyl benzyl, triphenyl methyl, allyl, 1-propynyl, R¹⁸

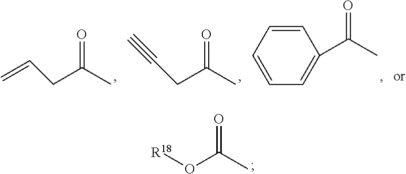

R¹⁶=each, independently, (C₁-C₈)alkyl; R¹⁷=each, independently, (C₁-C₈)alkyl; R¹⁸=each, independently, (C₁-C₁₅)alkyl, phenyl, or benzyl; R¹⁹=each, independently, H or (C₁-C₈)alkyl; and R²⁰=each, independently,

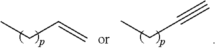

Further, the k and l units form a random copolymer. In some embodiments, the stimuli-responsive polymer includes a crosslinked derivative of Formula IIIB. The functional layer is an adhesive layer. In certain embodiments, the functional layer is a pressure sensitive adhesive layer. In many embodiments, the layered construction further includes at least one additional layer. In may embodiments, the layered construction further includes at least one additional functional layer. In some embodiments, the layered construction includes an additional functional layer, having a first and a second face, between the first layer and the PSA adhesive functional layer. The first side of the additional functional layer is located at the second side of the PSA adhesive functional layer, while the second side of the additional functional layer is located at the first side of the first layer. In some embodiments, the layered construction more than one additional functional layer. In many embodiments, the layered construction includes an additional functional layer between the first layer and the PSA adhesive functional layer, as well as a masking functional layer on the PSA adhesive functional layer. The masking functional layer has a first side and an oppositely directed second face. The second side of the masking functional layer is located on the first side of the other additional functional layer. The stimuli-responsive polymer in any of the additional functional layers can include any of the polymerized residues of Formula I, II, IIIA or IIIB, or a crosslinked derivative thereof, each of which is described herein.

In certain embodiments, the depolymerizable adhesive in the layered construction has a functional layer that further includes at least one second polymer. In some embodiments, the stimuli-responsive polymer may be blended with this second polymer. Examples of suitable second polymers include (meth)acrylates, polystyrenes, polyolefins, vinyl polymers, and the like.

The functional layer may also include any other components conventionally found in adhesive formulations, including, for example, tackifiers, pigments, colors or colorants, fillers, diluents, antioxidants, UV absorbers, and the like, and combinations thereof, provided that their inclusion does not impact the ability of the stimuli-responsive polymer to depolymerize.

In several embodiments, the layered construction includes a removable, printable top coat. In certain embodiments of the layered construction, the first layer is a facestock. Any suitable facestock may be used, such as those described hereinabove. The functional layer, which resides on the first side of the first layer, is a printable top coat. The top coat can be printed on by any suitable means, including printing by hand, typewriter, or conventional printing (such as flexographic printing, offset printing, inkjet printing, laser inkjet printing, videojet printing, thermal transfer, direct printing, gravure printing, and the like). Any suitable material can be used for the printable topcoat. In several embodiments, the stimuli-responsive polymer in the top coat functional layer includes the polymerized residues of Formula I:

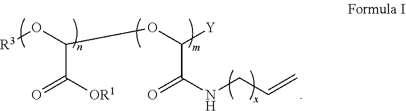

Wherein: n=0-1000; m=1-1000; x=1-15; Y=—CH₃, —CH₂R², —CH(R²)₂, or —OR²; R¹=each, independently, (C₁-C₈)alkyl, allyl, alkynyl, furfuryl, or N-methylmaleimide; R²=each, independently, (C₁-C₈)alkyl or allyl; and R³=methyl, allyl, 1-propynyl, benzyl, triphenyl methyl, or triphenylacetoxy. The m and n units form a random copolymer. In some embodiments, the stimuli-responsive polymer includes a crosslinked derivative of Formula I. In some embodiments, Formula I is selected from an atactic, isotactic, or syndiotactic polymer, or any combination thereof.

In several embodiments, the layered construction is useful as a depolymerizable ink construction. This construction eliminates the need for a printable top coat, and allows for the removal of the ink layer upon exposure of the layered construction to the appropriate stimulus. In certain embodiments of the layered construction, the first layer of the layered construction is a facestock. The facestock may be made of any suitable material, such as those described hereinabove. The ink containing functional layer is located on the first side of the first layer. In many embodiments, the stimuli-responsive polymer in the functional layer includes the polymerized residues of Formula I or a crosslinked derivative thereof, Formula II or a crosslinked derivative thereof, Formula IIIA or a crosslinked derivative thereof, or Formula IIIB or a cyclic derivative or crosslinked derivative thereof. The structures of the polymers of Formula I, Formula II, Formula IIIA and Formula IIIB are described herein-above.

The layered constructions are not limited to the layers described herein above. Different layers from one of the above-described constructions can be used with the layers of a different construction. In some embodiments, the layered constructions further include at least one additional layer. In some embodiments, the layered constructions further include multiple additional layers. In some embodiments at least one of the additional layers is a functional layer including a stimuli-responsive polymer. In some embodiments, each functional layer includes the same stimuli-responsive polymer. In some embodiments, each functional layer includes a different stimuli-responsive polymer. In some embodiments, at least one functional layer includes a different stimuli-responsive polymer. In some embodiments, at least two functional layers includes the same stimuli-responsive polymer. The stimuli-responsive polymer in any of the additional functional layers can include any of the polymerized residues of Formula I, II, IIIA or IIIB, or a crosslinked derivative thereof, each of which is described herein. In some embodiments, the layered construction includes at least one additional functional layer selected from a making layer, a pressure sensitive adhesive layer, a printable topcoat layer, a depolymerizable ink layer, or any combination thereof. In some embodiments, the layered construction includes at least one additional layer that is not a functional layer.

The polymers of Formula I, II, IIIA, and IIIB may be prepared by any suitable means. In some embodiments, the polymers of Formula I, II, IIIA, and IIIB may be prepared by end-capping poly(alkyl aldehydes), using methods including those described in related U.S. Provisional Application No. 63/218,037, incorporated herein in its entirety. In certain embodiments of the layered construction, the crosslinked derivatives of the polymers of Formula I, II, IIIA, or IIIB may be formed by crosslinked with conventional crosslinking chemistry known to those of skill in the art, including, but not limited to, thiol-ene, azide/alkyne, cross metathesis, or Diels-Alder chemistry. The polymers of Formula I, II, IIIA, and IIIB may be in crystalline, semi-crystalline, or amorphous form. The polymers of Formula I, II, IIIA, and IIIB may be formulated with additives to improve stability, including for example, acid scavengers, aldehyde scavengers, antioxidants, and combinations thereof.

In certain embodiments of the layered construction, the stimuli-responsive polymer is a part of a brush polymer. By “brush polymer” is meant herein a polymer having a main polymer chain, to which is tethered a plurality of smaller polymer chains. Brush polymers are well known in the art. In some embodiments, the stimuli-responsive polymer forms the main polymer chain. The smaller polymer chains tethered to the main polymer chain can have any suitable composition. For example, in some embodiments, the smaller polymer chains can be polymerized from at least one monomer selected from a (meth)acrylate, styrene, butadiene, acrylamide, cyanoacrylate, vinyl acetate, vinyl ether, or any combination thereof.

As noted hereinabove, the layered constructions of the invention may be used in a variety of different applications and methods where it is desirable to remove one or more of the layers, such as, for example, to permit recycling of the layered construction, recovery of the component layers or the construction, expose masked layers of the layered construction to avoid the use of non-essential layers of the layered construction, and the like.

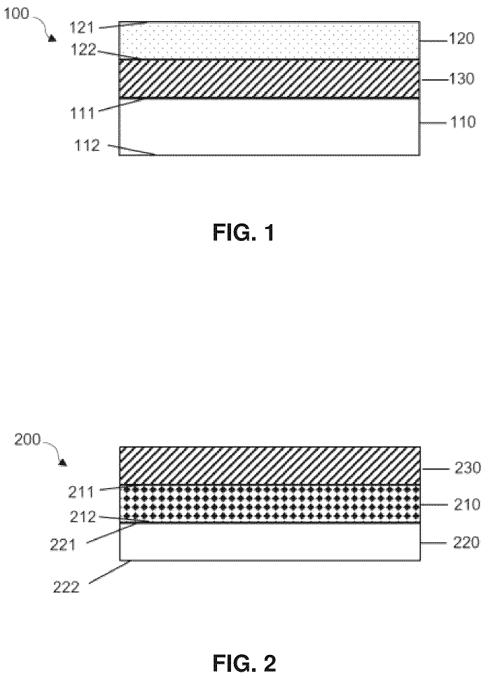

Many embodiments are related to methods of using the layered constructions described herein. In certain aspects, several embodiments are directed to methods of recycling a coated release liner, including the step of providing a layered construction, described herein, where the first layer is a base layer; and the second layer is a release coating. Any suitable release coating may be used, such as for example polydimethyl siloxane. The layered construction is exposed to a non-ambient stimulus. Any suitable non-ambient stimulus can be used, as long as it is capable of eliciting the desired response from the stimuli-responsive polymer, namely depolymerization. In many embodiments, the non-ambient stimulus is selected form the group of a base, acid, oxidizing agent, reducing agent, non-ionizing radiation, ultrasound, acid derived from a photoacid, ultraviolet light, infrared light, visible light, heat, and any combination thereof. One possible layered construction of this type is shown in FIG. 1, where a release liner 100 with the base layer 110 (with first side 111 and second side 112) and release coating 120 (with first side 121 and second side 122) are shown with the functional layer 130 there-between. In some embodiments, the duration of exposure of the layered construction to the non-ambient stimulus is sufficient to separate the first layer of the layered construction from the second layer. The exposure of the functional layer between the base layer and the release coating to the non-ambient stimulus for a sufficient length of time, causes the base layer to separate from the release layer. The separation is caused by the depolymerization of the stimuli-responsive polymer in the functional layer. Accordingly, the base layer and the release layer can be separately recycled.

In certain aspects, several embodiments are directed to methods of providing a linerless adhesive article, including the step of providing a layered construction described herein, where the first layer is an adhesive layer that functions as a pressure sensitive adhesive. The first pressure sensitive layer resides between a masking functional layer and a second layer that is a facestock. The layered construction is exposed to a non-ambient stimulus for a period of time that is sufficient to remove the functional layer from the first layer, thereby revealing the underlying adhesive and making the adhesive available for adherence to a substrate. Any suitable non-ambient stimulus can be used, as long as it is capable of eliciting the desired response from the stimuli-responsive polymer, namely depolymerization. In many embodiments, the non-ambient stimulus is selected form the group of a base, acid, oxidizing agent, reducing agent, non-ionizing radiation, ultrasound, acid derived from a photoacid, ultraviolet light, infrared light, visible light, heat, and any combination thereof. One possible layered construction of this type is shown in FIG. 2, where a linerless pressure sensitive adhesive construction 200 with the pressure sensitive adhesive layer 210 (with first side 211 and second side 212) and facestock 220 (with first side 221 and second side 222) are shown with the masking functional layer 230 on the first side 211 of the pressure sensitive adhesive layer 210. The masking functional layer is a non-tacky or substantially non-tacky layer that masks or protects the underlying adhesive layer, thereby preventing the adhesive from prematurely adhering to a substrate. The exposure of the functional layer to the non-ambient stimulus, for a sufficient length of time, causes the removal of the functional layer from the first layer to reveal the adhesive layer. The removal of the functional layer is caused by the depolymerization of the stimuli-responsive polymer in the functional layer. Accordingly, the linerless adhesive article is environmentally friendly and sustainable, as it does not require the use of a liner that must be removed and disposed of, prior to adherence of the adhesive article.

In some embodiments, the first layer of the lineless adhesive article is an adhesive layer including a stimuli-responsive polymer, thus the first layer is an adhesive functional layer. The method of providing the linerless adhesive article further includes the step of exposing the layered construction to a non-ambient stimulus for a time sufficient to remove the first layer from the second layer. Thus, the layered construction is exposed to at least one non-ambient stimulus for a period of time that is sufficient to remove the functional layer from the first layer, and to remove the first layer from the second layer. One or more non-ambient stimuli may be applied to the layered construction, depending on the type of stimuli-responsive polymer used in the adhesive layer and the masking functional layer. The type of non-ambient stimuli must elicit the desired response from the stimuli-responsive polymer in the target layer of the layered construction. In some embodiments, the layered construction is exposed to the same non-ambient stimulus to remove both the masking functional layer and the adhesive functional layer. In some embodiments, the layered construction is exposed to a first non-ambient stimulus to remove the masking functional layer, and a different second non-ambient stimulus to remove the adhesive functional layer. Accordingly, the linerless adhesive article is environmentally friendly and sustainable, as it does not require the use of a liner that must be removed and disposed of, prior to adherence of the adhesive article, and it enables the depolymerization of the functional adhesive.

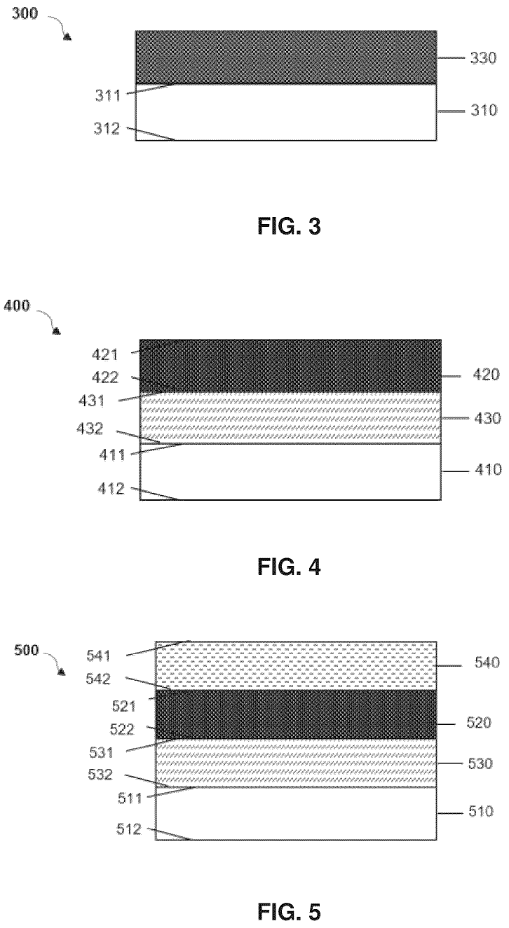

Certain embodiments are directed to methods of recycling, composting, and/or providing a degradable adhesive article. The method includes providing a layered construction described herein, where the first layer is a facestock layer. The functional layer, which resides on the first layer, functions as a pressure sensitive adhesive. The layered construction is exposed to a non-ambient stimulus for a time sufficient to separate the functional layer from the first layer. One possible layered construction of this type is shown in FIG. 3, where a pressure sensitive adhesive construction 300 with the facestock 310 (with first side 311 and second side 312) and is shown with the functional layer 330 that functions as a pressure sensitive adhesive on the first side 311 of the facestock 310. In many embodiments, the construction can include additional layers. In many embodiments, the construction includes at least one additional functional layer. FIG. 4 shows another possible construction, where a construction 400 has a facestock 410 (with first side 411 and second side 412), a functional layer 430 (with first side 431 and 432) on the first side 411 of the facestock 410, and a pressure sensitive adhesive layer that can be a second functional layer 420, (with first side 421 and second side 422), on the first side 431 of the functional layer 430. FIG. 5 shows another possible construction, where a construction 500 has a facestock 510 (with first side 511 and second side 512), a functional layer 530 (with first side 531 and second side 532) on the first side 511 of the facestock 510, a pressure sensitive adhesive layer 520 (with first side 521 and second side 522) that can, in some embodiments, be a functional layer, on the first side 531 of the functional layer 530, and an additional functional layer, namely a masking functional layer 540 (with first side 541 and second side 542) on the first side 521 of the pressure sensitive adhesive layer 520.

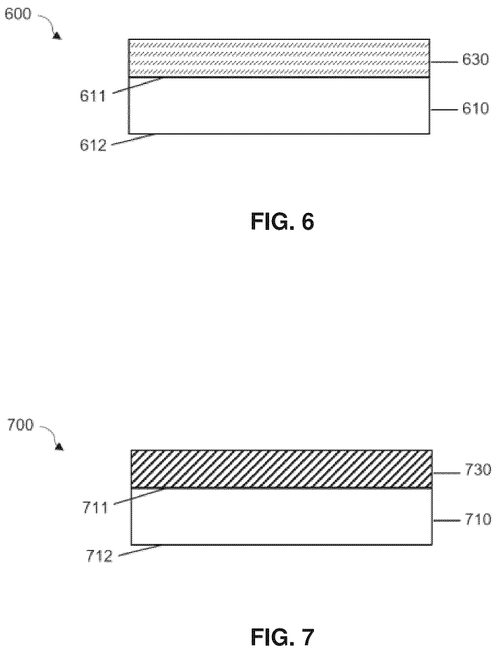

Certain embodiments are directed to methods of recycling a printed facestock, including providing a layered construction, where the first layer is a facestock layer. The functional layer, that resides on the first layer, is a printable top coat. In some embodiments, the layered construction further includes printed indicia on the top coat. The layered construction is exposed to a non-ambient stimulus for a time sufficient to separate the functional top coat from the first layer. The functional top coat separates from the first layer when the functional top coat depolymerizes. One possible layered construction of this type is shown in FIG. 6, where the printable topcoat construction 600 with the facestock 610 (with first side 611 and second side 612), is shown with the functional layer 630 on the first side 611 of the facestock 610.

Certain embodiments are directed to methods of recycling a printed facestock, including, providing a layered construction where the first layer is a facestock layer. The functional layer, which resides on the facestock, is an ink. The layered construction is exposed to a non-ambient stimulus for a time sufficient to separate the functional ink from the first layer. The functional ink separates from the first layer when the functional ink depolymerizes. One possible layered construction of this type is shown in FIG. 7, where the depolymerizable ink construction 700 has a facestock 710 (with first side 711 and second side 712) and a functional ink layer 730 on the first side 711 of the facestock 710.

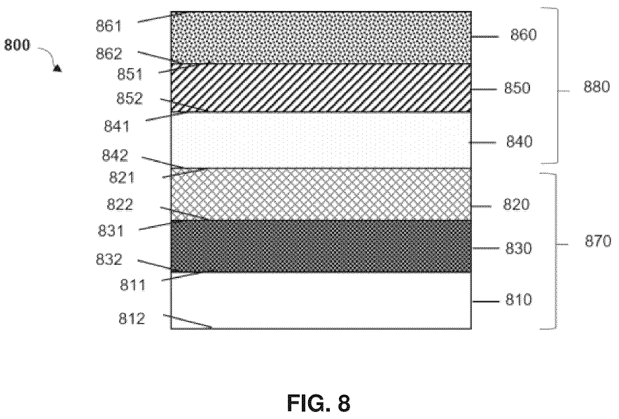

As noted hereinabove, in many embodiments, the construction can include additional layers. Any layer(s) of different embodiments of the invention can be combined with the layers of a different embodiment of the invention. The selection of the specific layers for a construction will be dependent upon which layers one seeks to separate from other layer(s). For example, FIG. 8 shows the construction of FIG. 4, in combination with the construction of FIG. 1 (rotated). The layered construction 800 has a facestock 810 (with first side 811 and second side 812), a functional layer 830 (with first side 831 and 832) on the first side 811 of the facestock 810, and a pressure sensitive adhesive 820 (with first side 821 and second side 822) on the first side 831 of the functional layer 830. In some embodiments, the pressure sensitive adhesive 820 is a functional layer. Together, layers 810, 820 and 830 function as a label 870. A depolymerizable release coating layer 840 (with first side 841 and second side 842) resides on the first side 821 of the pressure sensitive adhesive 820; a functional layer 850 (with first side 851 and 852) resides on the first side 841 of the functional release coating layer 840; and a base layer 860 (with first side 861 and 862) resides on the first side 851 of the functional layer 850. Together the layers 840, 850 and 860 function as a liner 880. The layered construction 800 can include even more layers. For example in some embodiments, the construction further includes a printable topcoat functional layer (not shown) on the first side 861 of the base layer 860. In some embodiments, the construction further includes a functional ink layer (not shown) on the first side 861 of the base layer 860.

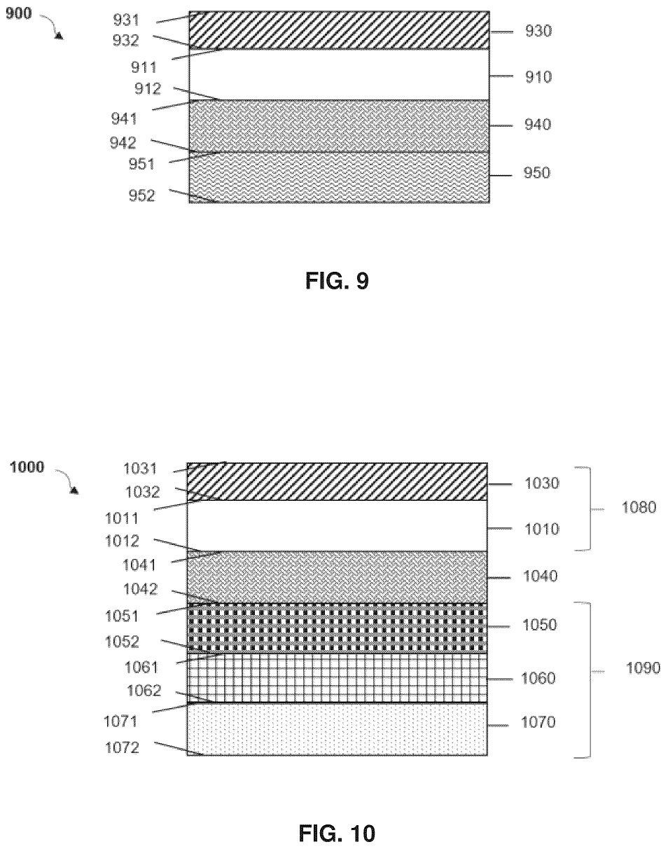

FIG. 9 and FIG. 10 show a depolymerizable ink construction such as that shown in FIG. 7, with various additional layers. FIG. 9 shows a construction 900 having a facestock 910 (with first side 911 and second side 912) and a functional ink layer 930 on the first side 911 of the facestock 910. The construction further includes a functional layer 940 (with first side 941 and second side 942) that functions as a pressure sensitive adhesive layer, on the second side of the facestock 910, and a masking functional layer 950 on the second side 942 of the functional layer 940. In some embodiments, the functional layer 940 is a pressure sensitive adhesive functional layer. In some embodiments, the functional layer 940 includes more than one layer. For example, in some embodiments, the functional layer includes a non-adhesive functional layer (not shown) and a pressure sensitive adhesive layer (not shown), where the non-adhesive functional layer (not shown) resides on the second side 912 of the facestock 910, and the pressure sensitive adhesive layer (not shown) resides between the non-adhesive functional layer (not shown) and the masking functional layer. FIG. 10 shows a depolymerizable ink construction such as that shown in FIG. 7, in combination with the construction of FIG. 1, along with additional layers. More specifically, FIG. 10 shows a construction 1000 having a facestock 1010 (with first side 1011 and second side 1012) and a functional ink layer 1030 on the first side 1011 of the facestock 1010, that together form a depolymerizable ink sub-construction 1080. The construction further includes a base layer 1070 (with first side 1071 and second side 1072), functional layer 1060 (with first side 1061 and second side 1062) on the first side 1071 of the base layer 1070, and functional release coating layer 1050 (with first side 1051 and second side 1052) on the first side of the functional layer 1060, which collectively form a recyclable liner sub-construction 1090. A functional layer 1040 resides between the facestock 1010 of the depolymerizable ink sub-construction 1080 and functional release layer 1050 of the recyclable liner sub-construction 1090. In some embodiments, the functional layer 1040 is a pressure sensitive adhesive functional layer. In some embodiments, the functional layer 1040 includes more than one layer. For example, in some embodiments, the functional layer 1040 includes a non-adhesive functional layer (not shown) and a pressure sensitive adhesive layer (not shown), where the non-adhesive functional layer (not shown) resides on the second side 1012 of the facestock 1010, and the pressure sensitive adhesive layer (not shown) resides between the non-adhesive functional layer (not shown) and the release functional layer 1050.

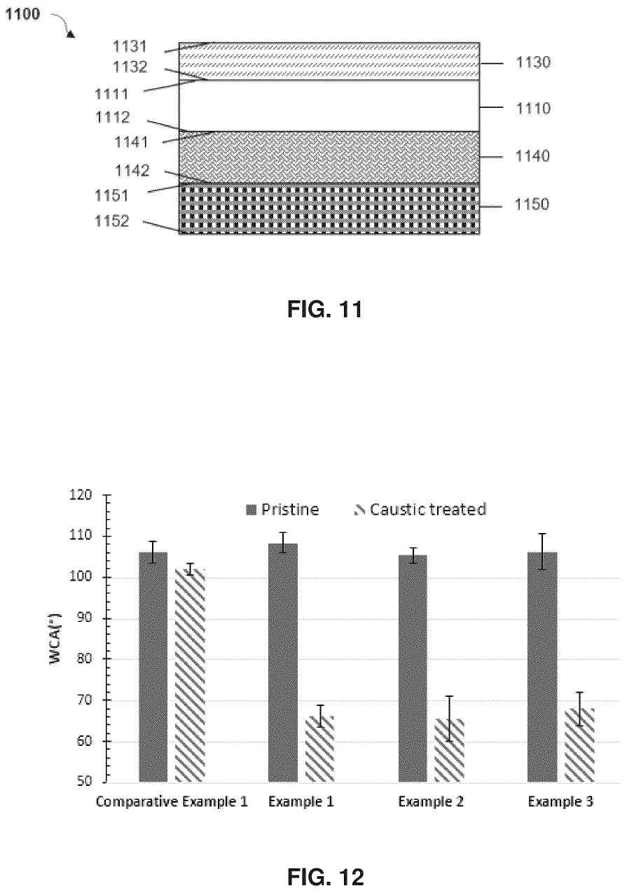

FIG. 11 shows a printable topcoat construction such as that shown in FIG. 6, with various additional layers. FIG. 11 shows construction 1100 with the facestock 1110 (with first side 1111 and second side 1112) and is shown with the functional topcoat layer 1130 on the first side 1111 of the facestock 1110. The construction further includes a functional pressure sensitive adhesive layer 1140 on the second face 1112 of the facestock 1110, and a functional masking layer 1150 on the second side 1142 of the functional pressure sensitive adhesive layer 1140. In some embodiments, the construction further includes an ink layer (not shown) on the first side 1131 of the functional topcoat 1130.

In each of the embodiments, the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof. In some embodiments, the non-ionizing radiation can be selected from ultraviolet light, ultraviolet-visible light, infrared radiation, microwave, radio waves, or thermal radiation.

In any of the embodiments, the layered construction can further include an ink layer as it outermost layer. The ink layer can fully or partially cover the underlying layer. In many embodiments, the ink layer is a printed indicia.

It will be understood that where the layered construction is exposed to a non-ambient stimulus to remove a functional layer of the construction from another layer, the removal occurs by depolymerization of the stimuli-responsive polymer in the functional layer. The removal does not require the full depolymerization of the functional layer. Thus, in some embodiments, the depolymerization is a full depolymerization. In some embodiments, the depolymerization is an at least partial depolymerization. In some embodiments, the depolymerization is a partial depolymerization.

The following embodiments are contemplated. All combinations of features and embodiments are contemplated.

Embodiment 1: A layered construction, comprising: a first layer comprising a first side and a second side; and a functional layer applied on a portion of the first side of the first layer or the second side of the first layer; wherein the functional layer comprises a stimuli-responsive polymer.

Embodiment 2: The layered construction of Embodiment 1, wherein the stimuli-responsive polymer responds to at least one specific, non-ambient stimuli selected from the group consisting of base, acid, oxidizing agent, reducing agent, non-ionizing radiation, ultrasound, acid derived from a photoacid, ultraviolet light, infrared light, visible light, heat, and combinations thereof.

Embodiment 3: The layered construction of Embodiment 1, wherein the stimuli-responsive polymer is a polymer selected from the group consisting of poly(aldehyde), poly(olefin sulfone), poly(cyanoacrylate), poly(glyoxylate), poly(glyoxamide), poly(isocyanate), poly(quinone methide), poly(benzyl ether), poly(carboxy pyrrole), poly(dialdehyde), poly(dithiothreoitol), poly(benzyl carbamate), copolymers thereof, cyclic polymers thereof, and combinations thereof.

Embodiment 4: The layered construction of Embodiment 1, wherein the stimuli-responsive polymer is selected from the group consisting of a poly(glyoxamide) poly(glyoxylate)-poly(glyoxamide) copolymer, poly(glyoxylate), poly(alkyl aldehyde) derivative, and combinations thereof.

Embodiment 5: The layered construction of Embodiment 1, wherein the stimuli-responsive polymer is at least one of a poly(glyoxamide) and poly(glyoxamide)-poly(glyoxylate) copolymer having at least one terminal alkene.

Embodiment 6: The layered construction of Embodiment 1, wherein the stimuli-responsive polymer is at least one of a poly(allyl glyoxamide) and poly(allyl glyoxamide)-poly(glyoxylate) copolymer.

Embodiment 7: The layered construction of Embodiment 1, further comprising: a second layer comprising a first side and a second side; wherein the second layer is applied to the first side of the functional layer; and wherein the functional layer applied to the first side of the first layer.

Embodiment 8: The layered construction of Embodiment 7, wherein the first layer and the second layer have dissimilar compositions.

Embodiment 9: The layered construction of Embodiment 7, wherein the first layer is a base layer; wherein the second layer is a release coating; and wherein the stimuli-responsive polymer comprises the polymerized residues of Formula I:

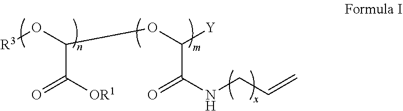

wherein:
m=0-1000 units;
n=0-1000 units;
x=1-15;
Y=—CH3, —CH2R2, —CH(R2)2, —CH(R2)3, or —OR2;
R1=each, independently, H, (C1-C8)alkyl, allyl, alkynyl, furfuryl, or N-methylmaleimide;
R2=each, independently, H, (C1-C8)alkyl or allyl; and
R3=methyl, allyl, 1-propynyl, benzyl, triphenyl methyl, or triphenylacetoxy;
wherein the m and n units form a random copolymer;
or a crosslinked derivative of Formula I.

Embodiment 10: The layered construction of Embodiment 9, further including at least one additional functional layer.

Embodiment 11: The layered construction of Embodiment 1, further comprising: a second layer comprising a first side and a second side; wherein the second layer is applied to the second side of the first layer; and wherein the functional layer is located on the first side of the first layer; wherein the first layer is an adhesive layer; wherein the second layer is a facestock; and wherein the stimuli-responsive polymer comprises the polymerized residues of Formula II:

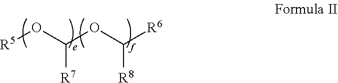

wherein:
e=1-1000 units;
f=0-1000 units;
g=1-15;
X=each, independently, O or NH;
R⁵=each, independently, H, (C₁-C₇)alkyl, allyl, 1-propynyl,

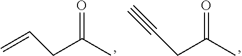

benzyl, triphenylmethyl,

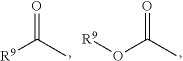

or R¹⁰ (wherein optionally at least one of R⁵ and R⁶=R¹⁰);
R⁶=each, independently, (C₁-C₈)alkyl, phenyl, benzyl,

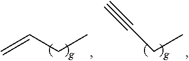

or —X—R¹¹; and
R⁷=each, independently, (C₁-C₂₀)alkyl,

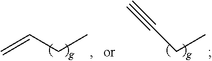

R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl,

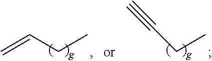

wherein e and f units form a random or block copolymer;
or a cyclic derivative or crosslinked derivative of Formula II.

Embodiment 12: The layered construction of Embodiment 11,
wherein R¹⁰=

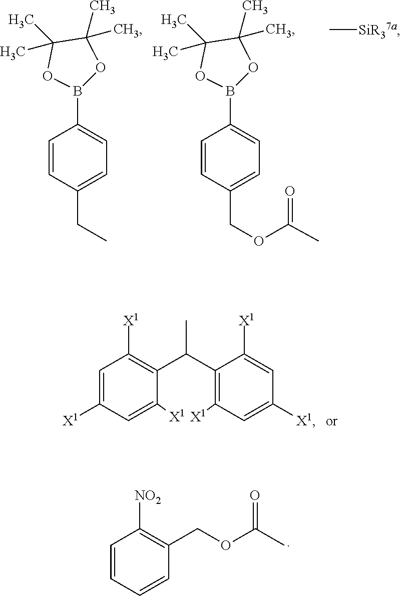

wherein:
R^{7a}=each, independently, (C₁-C₂₀)alkyl, phenyl, benzyl,

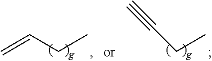

and
X¹=each, independently, H, (C₁-C₃)alkoxy, or NR⁷¹; and
R^{7b}=each, independently, (C₁-C₂)alkyl.

Embodiment 13: The layered construction of Embodiment 11, wherein the adhesive layer is a functional adhesive layer comprising a stimuli-responsive polymer, wherein the stimuli-responsive polymer comprises polymerized residues of Formula IIIA or Formula IIIB, wherein Formula IIIA has a structure:

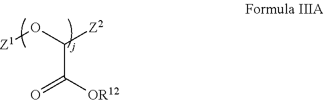

wherein:
h=1-15;
j=1-1000;
Z¹=

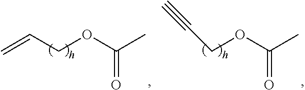

benzyl, triphenyl methyl, allyl, 1-propynyl,

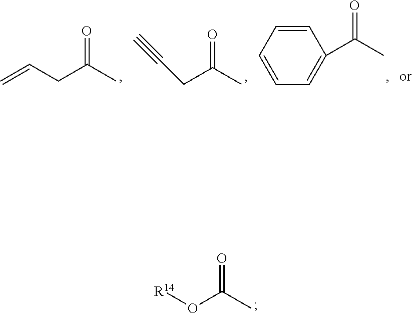

Z²=each, independently, (C₁-C₁₅)alkyl, (C₁-C₁₅)alkyoxy,

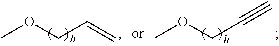

R¹²=each, independently, (C₁-C₇)alkyl;
R¹⁴=each, independently, (C₁-C₁₅)alkyl, phenyl, or benzyl; or crosslinked derivative of Formula IIIA;
wherein Formula IIIB has a structure:

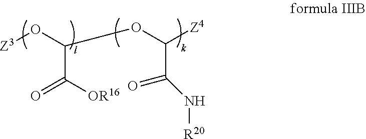

wherein:
k=1-1000 units;
l=0-1000 units;
p=each, independently, 1-15;
   Z³=

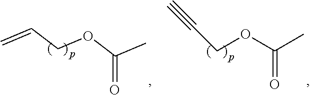

or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl,

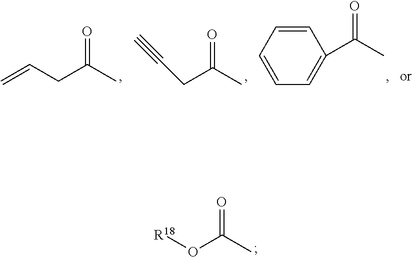

R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently,

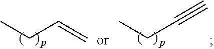

wherein k and l units form a random copolymer;
or crosslinked derivative of Formula IIIB.

Embodiment 14: The layered construction of Embodiment 11, further including at least one additional functional layer.

Embodiment 15: The layered construction of Embodiment 1, wherein the first layer is a facestock; wherein the functional layer is located on the first side of the first layer; and wherein the stimuli-responsive polymer comprises the polymerized residues of Formula IIIA or Formula IIIB, wherein Formula IIIA has a structure:

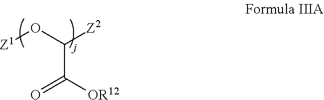

wherein:
h=1-15;
j=1-1000;
   Z¹=

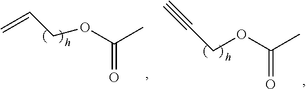

benzyl, triphenyl methyl, allyl, 1-propynyl,

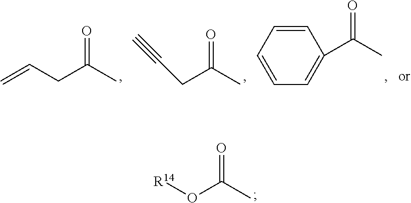

Z²=each, independently, (C₁-C₁₅)alkyl, (C₁-C₁₅)alkyoxy,

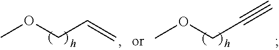

R¹²=each, independently, (C₁-C₇)alkyl;
R¹⁴=each, independently, (C₁-C₁₅)alkyl, phenyl, or benzyl;
or crosslinked derivative of Formula IIIA;
wherein Formula IIIB has a structure:

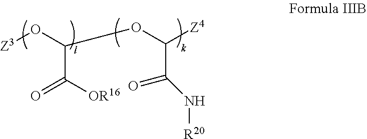

wherein:
k=1-1000 units;
l=0-1000 units;
p=each, independently, 1-15;
   Z³=

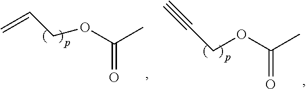

or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl,

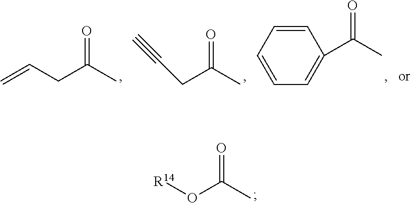

R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, or

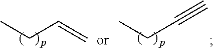

wherein k and l units form a random copolymer;
or crosslinked derivative of Formula IIIB.

Embodiment 16: The layered construction of Embodiment 15, further including at least one additional functional layer.

Embodiment 17: The layered construction of Embodiment 16, wherein at least one of the additional functional layers is a masking layer.

Embodiment 18: The layered construction of Embodiment 15, wherein the functional layer further comprises a second polymer.

Embodiment 19: The layered construction of Embodiment 1, wherein the first layer is a facestock; wherein the functional layer is a printable top coat; and wherein the stimuli-responsive polymer comprises the polymerized residues of Formula I:

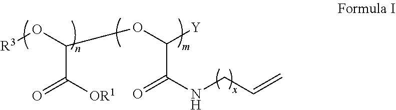

wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy; wherein the m and n units form a random copolymer;
or a crosslinked derivative of Formula I.

Embodiment 20: The layered construction of Embodiment 1, wherein the first layer is a facestock; wherein the functional layer comprises an ink; and wherein the stimuli-responsive polymer comprises the polymerized residues of at least one of Formula I, a crosslinked derivative of Formula I, Formula II, a cyclic derivative of Formula II, a crosslinked derivative Formula II, Formula IIIA, a crosslinked derivative of Formula IIIA, a crosslinked derivative of Formula IIIA, Formula IIIB, and a crosslinked derivative of Formula IIIB, wherein Formula I has a structure:

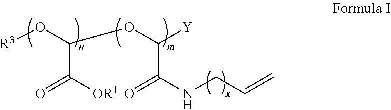

wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure:

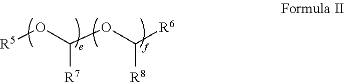

wherein:
e=1-1000 units;
f=0-1000 units;
g=1-15; X=each, independently, O or S;
R⁵=each, independently, H, (C₁-C₇)alkyl, allyl, 1-propynyl,

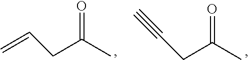

benzyl, triphenylmethyl,

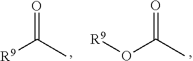

or R¹⁰ (wherein optionally at least one of R⁵ and R⁶=R¹⁰);
R⁶=each, independently, (C₁-C₈)alkyl, phenyl, benzyl,

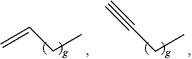

or —X—R¹¹; and
R⁷=each, independently, (C₁-C₂₀)alkyl,

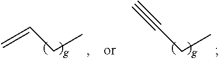

R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl,

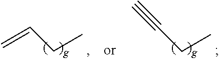

wherein e and f units form a random or block copolymer;
wherein Formula IIIA has a structure:

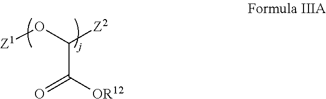

wherein:
h=1-15;
j=1-1000;
Z¹=

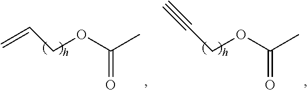

benzyl, triphenyl methyl, allyl, 1-propynyl,

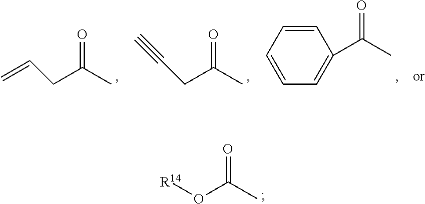

Z²=each, independently, (C₁-C₁₅)alkyl, (C₁-C₁₅)alkyoxy,

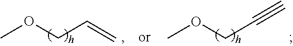

R¹²=each, independently, (C₁-C₇)alkyl;
R¹⁴=each, independently, (C₁-C₁₅)alkyl, phenyl, or benzyl; and
wherein Formula IIIB has a structure:

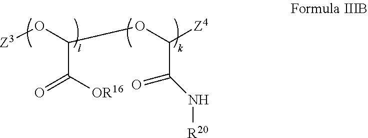

wherein:
k=1-1000 units;
l=0-1000 units;
p=each, independently, 1-15;
Z³=

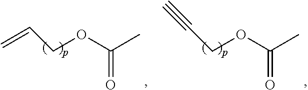

or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl,

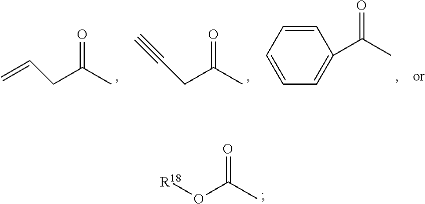

R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently,

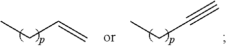

wherein k and l units form a random copolymer.

Embodiment 21: The layered construction of Embodiment 20, wherein R¹⁰=

wherein:

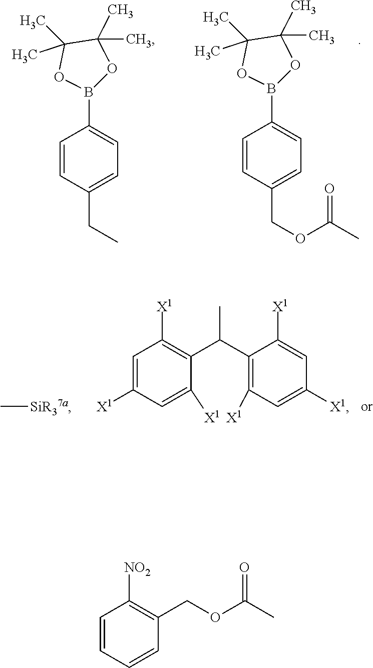

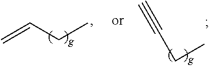

R^{7a}=each, independently, (C₁-C₂₀)alkyl, phenyl, benzyl,
and
X¹=each, independently, H, (C₁-C₃)alkoxy, or NR⁷¹; and
R^{7b}=each, independently, (C₁-C₂)alkyl.

Embodiment 22: The layered construction of Embodiment 20, wherein the ink is in the form of a printed indicia.

Embodiment 23: The layered construction of Embodiment 20, further including at least one additional functional layer.

Embodiment 24: The layered construction of any one of Embodiments 10, 14, 16 or 23, wherein the least one additional functional layer comprises at least one stimuli-responsive polymer; wherein at least one of the stimuli-responsive polymer functional layer comprises polymerized residues selected from the group consisting of Formula I or a crosslinked derivative thereof, Formula II or a cyclic derivative or crosslinked derivative, Formula IIIA or a crosslinked derivative thereof, or Formula IIIB or a crosslinked derivative thereof; wherein Formula I has a structure:

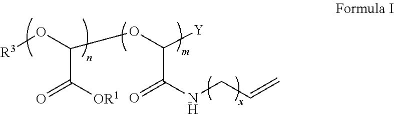

wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure:

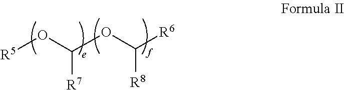

wherein:
e=1-1000 units;
f=0-1000 units;
g=1-15;
X=each, independently, O or NH;
R⁵=each, independently, H, (C₁-C₇)alkyl, allyl, 1-propynyl,

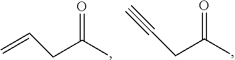

benzyl, triphenylmethyl,

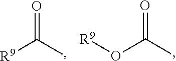

or R¹⁰ (wherein optionally at least one of R⁵ and R⁶=R¹⁰);
R⁶=each, independently, (C₁-C₈)alkyl, phenyl, benzyl,

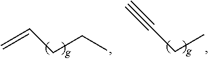

or —X—R¹¹; and
R⁷=each, independently, (C₁-C₂₀)alkyl,

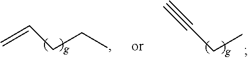

R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl,

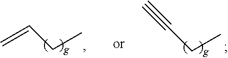

and
wherein e and f units form a random or block copolymer;
wherein Formula IIIA has a structure:

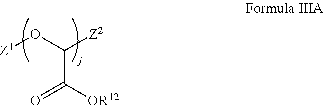

wherein:
h=1-15;
j=1-1000;
Z¹=

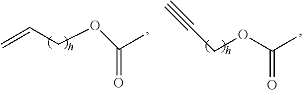

benzyl, triphenyl methyl, allyl, 1-propynyl,

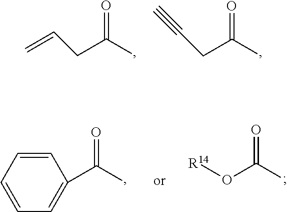

Z²=each, independently, (C₁-C₁₅)alkyl, (C₁-C₁₅)alkyoxy,
R¹²=each, independently, (C₁-C₇)alkyl;
R¹⁴=each, independently, (C₁-C₁₅)alkyl, phenyl, or benzyl; and

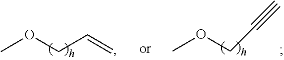

wherein Formula IIIB has a structure:

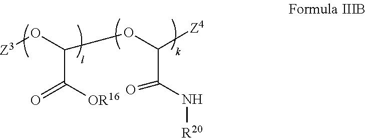

wherein:
k=1-1000 units;
l=0-1000 units;
p=each, independently, 1-15;

Z³=

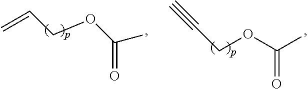

or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl,

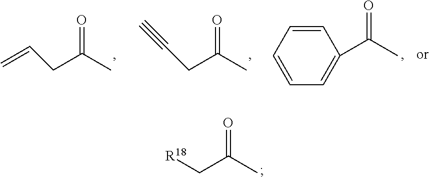

R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently,

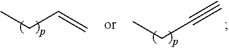

wherein k and l units form a random copolymer.

Embodiment 25: A method of recycling a coated release liner, comprising: providing the layered construction of Embodiment 7 or Embodiment 9; wherein the first layer is a base layer; and wherein the second layer is a release coating; exposing the layered construction to a non-ambient stimulus for a time sufficient to separate the first layer from the second layer.

Embodiment 26: The method of recycling a coated release liner of Embodiment 25, wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

Embodiment 27: A method of providing a linerless adhesive article, comprising: providing the layered construction of Embodiment 11; wherein the first layer is an adhesive layer; and wherein the second layer is a facestock; and exposing the layered construction to a non-ambient stimulus for a time sufficient to remove the functional layer from the first layer to reveal the adhesive layer.

Embodiment 28: The method of Embodiment 27, wherein the adhesive layer comprises a stimuli-responsive polymer; and wherein the layered construction is exposed to a non-ambient stimulus for a time sufficient to remove the first layer from the second layer.

Embodiment 29: The method of Embodiment 27 or Embodiment 28, wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

Embodiment 30: A method of recycling, composting, and/or providing a degradable adhesive article, comprising: providing the layered construction of claim 1 or 15; wherein the first layer is a facestock layer; and wherein the functional layer functions as a pressure sensitive adhesive; and exposing the layered construction to a non-ambient stimulus for a time sufficient to depolymerize the functional layer.

Embodiment 31: The method of Embodiment 30, wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

Embodiment 32: A method of recycling a printed facestock, comprising: providing the layered construction of Embodiment 1 or Embodiment 19; wherein the first layer is a facestock layer; and wherein the functional layer is a printable top coat; wherein the layered construction further comprises printed indicia on the top coat; and exposing the layered construction to a non-ambient stimulus for a time sufficient to depolymerize the functional layer.

Embodiment 33: The method of Embodiment 32, wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

Embodiment 34: A method of recycling a printed facestock, comprising: providing the layered construction of Embodiment 1 or Embodiment 20; wherein the first layer is a facestock; wherein the functional layer is an ink; and exposing the layered construction to a non-ambient stimulus for a time sufficient depolymerize the functional layer.

Embodiment 35: The method of Embodiment 34, wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

When ranges are used herein for physical properties, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### EXAMPLES

### Recyclable Liner

A polymer derivative from Formula I was dissolved in toluene at 10-50 wt. %, and using an AP JR00 rod a film, was drawn onto the first side of a PET (polyethylene terephthalate) base layer. Upon drying at 120° C. for 1-5 min, a functional tie layer was obtained at 0.5-2 gsm. Polydimethyl siloxane (PDMS) (Sylgard® 184 from Dow Corning®) part A (base elastomer containing vinyl groups) and part B (elastomer curing agent containing hydrosiloxane groups) were mixed in a ratio 93.5:6.5 wt. %, and the mixture was coated on top of the functional tie layer using an AP JR00 rod and cured at 120° C. for 0.5-5 min. The final cured thickness of the functional release coating layer was 0.5-2 gsm.

Caustic washing to enable recycling of the release liner was performed according the guidelines established by the Association of Plastic Recyclers (APR) Document Number PET-P-00 (PET Standard Laboratory Processing Practices) on a commercially available liner (Comparative Example 1), a sample of the above-prepared liner (Example 1), a pressure-aged sample of the above-prepared liner (Example 2), and a tropical-aged sample of the above-prepared liner (Example 3).

FIG. 12 shows water contact angle (WCA) data on the examples before and after caustic treatment. In pristine state, Example 1 had a similar WCA to that of the commercial liner of Comparative Example 1 (i.e. 108±3°). Upon pressure aging (120 PSI for 3 days) and tropical aging (70° C., 70% RH, 7 days), as shown in the results for Examples 2 and 3 respectively, the WCA of the prepared recyclable liner remained the same, proving the robustness of the functional layer and of the entire construction. Once caustic treated as per the procedure from Association of Plastic Recyclers (APR) Document Number PET-P-00, the WCA for Example 1 dropped from 108±3° to 66±4°. The pressure aged and tropical aged liners of Examples 2 and 3, respectively, also showed similar changes in WCA upon caustic treatment. The commercial liner of Comparative Example 1, on the hand showed drops in WCA of only 102±2°, a minor change caused potentially due to surface oxidation. The contrast in WCA between the untreated and caustic treated samples for Examples 1, 2 and 3, as compared to Comparative Example 1, suggested that Examples 1 to 3 were able to separate the release coating layer from the base layer.

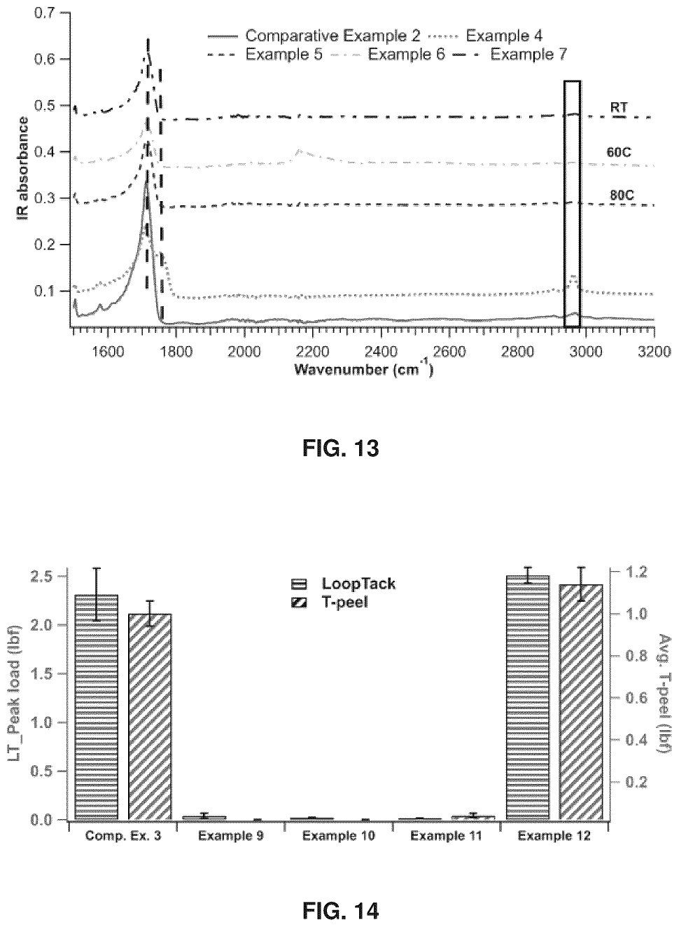

FIG. 13 shows FTIR (Fourier-transform infrared spectroscopy) FTIR spectra for a PET (polyethylene terephthalate) film (Comparative Example 2), and for the liner of Example 1, in pristine state (Example 4) and in post caustic treatment states, after caustic washing at 80° C. (Example 5), 60° C. (Example 5) and room temperature (Example 7). The key peak at 1712 cm⁻¹ was assigned to C═O vibration next to phenyl group in PET. Pristine spectrum for the functional tie layer showed a 1712 cm⁻¹ peak from PET in the base layer, but additionally showed peaks at 1752 cm⁻¹ for C═O from Formula I from the functional tie layer, and at 2962 cm⁻¹ for Si—CH₃ from the functional release coating layer. After caustic washing the liner of Example 1, the 1752 cm⁻¹ and 2962 cm⁻¹ peaks disappeared, and the only prominent peak was 1712 cm⁻¹ coming from the PET from the base layer. These FTIR spectra confirm that the functional release coating layer was removed, and no traces of the functional tie layer were left behind, thus the base layer was completely recovered layer for recycling.

### Linerless Pressure Sensitive Adhesive Construction

A polymer derivative from Formula II was dissolved in THF (tetrahydrofuran) at 20-50 wt. %. A photoacid was added at 1-2 wt. % of the polymer. Then the mixture was dried to form a functional masking layer. The functional masking layer was transfer coated onto the side of a pressure sensitive adhesive (PSA) layer that had a facestock layer residing on its opposite side, thereby forming the construction of Example 8. The thickness of the functional masking layer was 0.5-3 gsm.

FIG. 14 shows adhesion testing results for the construction. LoopTacks (LT) were measured on stainless steel panels, whereas T-peels were measured between PET substrates. A reference PSA on a PET facestock (Comparative Example 3) had LT of 2.25 lbf and T-peel of 1.1 lbf. When the functional masking layer was transfer coated to the PSA, it completely masked the PSA adhesion, as seen by infinitesimal LTs and T-peels. The construction of Example 8 was subjected to pressure aging (120 PSI, 3 days) and tropical aging (70 C, 70% RH, 7 days). Upon pressure aging and tropical aging, the adhesion was still infinitesimally small, suggesting the robustness and specificity of the functional masking layer. Upon exposure to UVC radiation of 35 mJ/cm2, both the LT and T-peel returned to substantially the original unmasked PSA values. Thus, suggesting complete adhesion recovery due to removal of the functional masking layer, as a result of UVC exposure.

TABLE 1
Adhesion Testing Parameters

| Example | Construction | Conditions |
|---|---|---|
| Comp. Ex. 3 | Facestock + PSA | |
| Ex. 9 | Ex. 8 | |
| Ex. 10 | Ex. 8 | Pressure aged (120 PSI, 3 days) |
| Ex. 11 | Ex. 8 | Tropical aged (70° C., 70% RH, 7 days) |
| Ex. 12 | Ex. 8 | UVC radiation (35 mJ/cm2) |

### Removable Printable Top Coat Construction

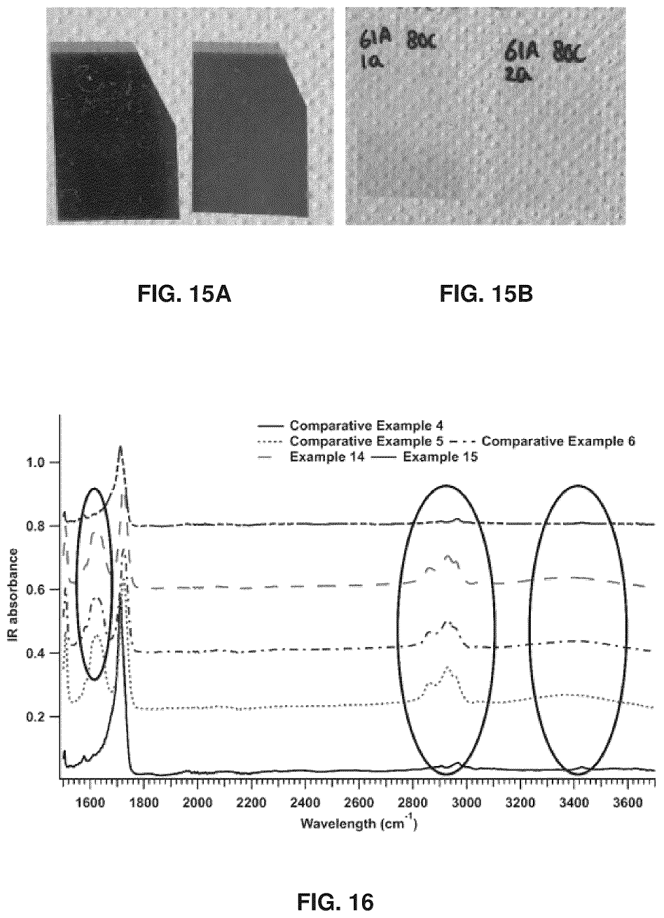

PET facestocks were coated with a topcoat containing a functional depolymerizable polymer including the polymerized residues of Formula I, creating the construction of Example 13. A black ink was deposited by printing on the outwardly facing surface of the functional topcoats. The constructions were subjected to caustic wash according to the protocol prescribed by Association of Plastic Recyclers (APR) Document Number PET-P-00. FIG. 15A shows an image of the pristine constructions, before caustic wash was performed, and FIG. 15B shows an image of the constructions after caustic wash was performed. For Comparative Example 4, a black ink was deposited on a PET facestock without the depolymerizable polymer topcoat layer. FIGS. 15A and 15B show that ink was removed from the facestock by the caustic wash.

TABLE 2
IR Testing Parameters

| Example | Construction | Conditions |
|---|---|---|
| Comp. Ex. 4 | PET − no ink | |
| Comp. Ex. 5 | PET + ink | Pre-caustic wash |
| Comp. Ex. 6 | PET + ink | Post-caustic wash |
| Ex. 14 | Ex. 13 + ink | Pre-caustic wash |
| Ex. 15 | Ex. 13 + ink | Post-caustic wash |

FIG. 16 shows FTIR spectra of the constructions under various conditions. The FTIR spectra confirm the removal of the ink and of the depolymerizable functional topcoat layer.

The spectrum for Comparative Example 4 showed characteristic C═O next to phenyl ring 1712 cm-1. The spectra for pre-caustic wash Comparative Example 5 and Example 14 showed 1620 cm-1 stretch from —NH bend and a broad peak around 3400 cm-1 from —NH stretch, both coming from the ink layer. The spectrum for Comparative Example 6 did not look any different than that for Comparative Example 5, indicating the lack of ink removal. Whereas the spectrum for post-wash Example 15 did not show any 1620 and 3400 cm-1 peaks, with only a characteristic peak of 1712 cm-1 showing up, which came from the PET. This confirmed the removal of the ink and of the functional depolymerizable topcoat layer, and the complete recovery of the PET facestock for recycling.

### Depolymerizabe Ink Construction

A depolymerizable ink was made by mixing a pigment/dye into a depolymerizable polymer matrix containing a functional depolymerizable polymer including the polymerized residues of Formula I, which was coated directly onto a PET facestock, creating the depolymerizable ink construction of Example 16. The construction of Example 16 was subjected to a caustic wash as per the procedure from Association of Plastic Recyclers (APR) Document Number PET-P-00.

TABLE 3
IR Testing Parameters

| Example | Construction | Conditions |
|---|---|---|
| Comp. Ex. 7 | PET − no ink | |
| Ex. 17 | Ex. 16 + ink | Pre-caustic wash |
| Ex. 18 | Ex. 16 + ink | Post-caustic wash |

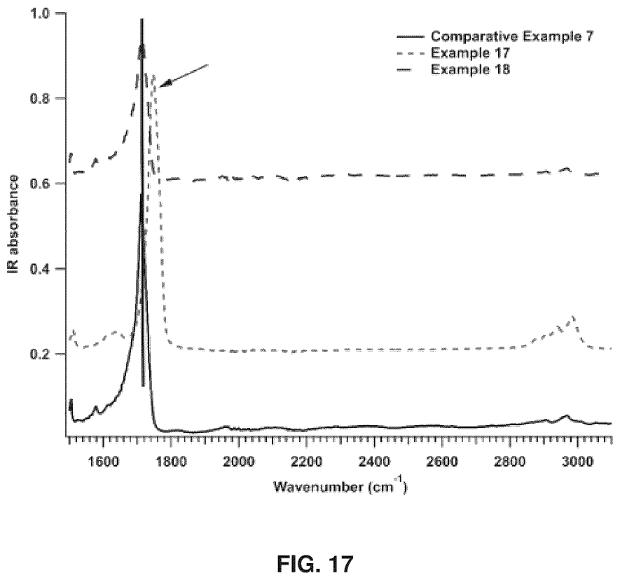

FIG. 17 shows the FTIR spectra for a PET film, as well as for Example 16 before and after caustic washing. Comparative Example 7 had the characteristic peak at 1712 cm-1 coming from the C═O next to phenyl ring. The pre-caustic wash Example 17 had a R—C═O peak at 1750 cm-1, and some peaks from the 2800-3000 cm-1 region for C—H stretches originating from the depolymerizable polymer ink. For post-wash Example 18, the 1750 cm-1 peak had vanished, and the aliphatic hydrocarbon stretches had diminished, leaving only the characteristic peak at 1712 cm-1 coming from PET. This confirmed the removal of the functional ink made from the depolymerizable polymers, and the recovery of the PET facestock.

### Depolymerizable PSA Construction

Afunctional PSA, made from a depolymerizable polymer including the polymerized residues of Formula IIIB, was transfer coated onto a BOPP (biaxially-oriented polypropylene) facestock. The construction was applied to a PET bottle, which was subjected to a caustic wash as per the procedure from Association of Plastic Recyclers (APR) Document Number PET-P-00. The bottle to which the construction was attached was cut into 1 cm*1 cm pieces (50 count) and added to a beaker containing 150 mL of 1% caustic in aqueous solution. The washoff was done at 80° C. with 1000 rpm stirring. Table 4 shows the results of the caustic washoff testing. The results were compared to those of comparative construction including a commercial general purpose PSA (Fasson® S692N, manufactured by Avery Dennison Corporation) that was coated onto a BOPP facestock, applied to a PET bottle, and subjected to a caustic wash.

TABLE 4
Caustic Wash Testing

| Example | PSA Type | % Wash Off |
|---|---|---|
| Comp. Ex. 8 | Conventional | 0% |
| Ex. 19 | Functional | 99% |

The results show that the functional PSA degraded under caustic, due to depolymerization of the functional polymer. This enabled recycling of the PET bottle, as well as the BOPP facestock. There was no adhesive residue leftover since the polymer depolymerized down to small molecules and oligomers. The conventional PSA remained on the bottle, even after the caustic wash.

### Degradable Adhesive Construction

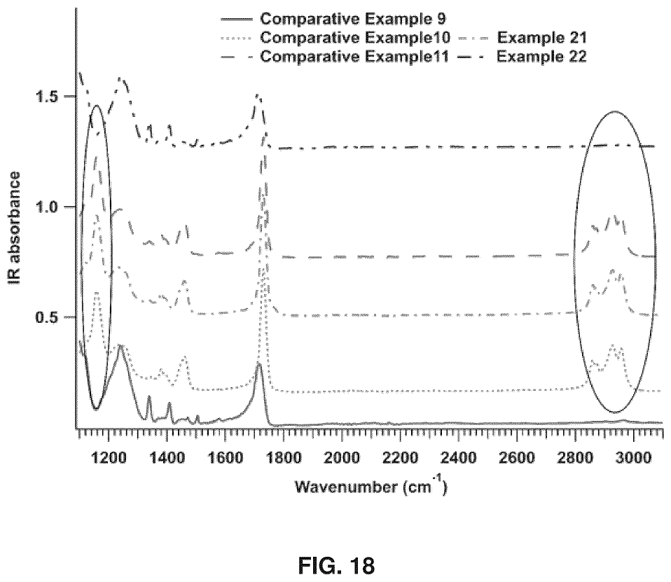

A construction including a functional tie coating containing a functional depolymerizable polymer including the polymerized residues of Formula I, residing in between a PSA layer and a PET facestock, was made, creating the construction of Example 20. The functional tie coating depolymerized under caustic wash conditions, thereby separating the PSA from the facestock. This enabled recycling of the facestock without any contamination from the PSA and the functional tie coating. The construction was subjected to a caustic wash as per the procedure from Association of Plastic Recyclers (APR) Document Number PET-P-00. FIG. 18 shows the FTIR spectroscopy data for the construction, as well as for a PET film, and a PET film with a PSA layer that was also subjected to a caustic wash.

TABLE 5
IR Testing Parameters

| Example | Construction | Conditions |
|---|---|---|
| Comp. Ex. 9 | PET | |
| Comp. Ex. 10 | PET + PSA | Pre-caustic wash |
| Comp. Ex. 11 | PET + PSA | Post-caustic wash |
| Ex. 21 | Ex. 20 | Pre-caustic wash |
| Ex. 22 | Ex. 20 | Post-caustic wash |

Comparative Example 9 showed characteristic C═O next to phenyl ring 1712 cm-1. Spectra for pre-caustic wash Comparative Example 10 and Example 21, showed an aliphatic C═O peak at 1750 cm-1, hydrocarbon stretches from 2800-3000 cm-1 and a fingerprint region peak around 1150 cm-1. The spectrum for post-caustic wash Comparative Example 11 did not look any different from that of the pristine Comparative Example 10, indicating the lack of PSA removal. Whereas the spectrum for post-caustic wash Example 22 did not show any aliphatic C═O peak at 1750 cm-1, hydrocarbon stretches from 2800-3000 cm-1 or fingerprint region peak around 1150 cm-1. The only characteristic peak seen was at 1705 cm-1, from phenyl C═O, and the spectrum was identical to the PET only spectrum of Comparative Example 9. This confirmed the removal of the functional depolymerizable tie layer, recovering the PET facestock completely for recycling.

1. A layered construction, comprising:
a first layer comprising a first side and a second side;
wherein the first layer, an adhesive layer, or a facestock layer,
wherein the base layer is selected from the group consisting of a paper, polymeric film, fabric, metallic foil, and combinations thereof; and
a functional layer applied on a portion of the first side of the first layer or the second side of the first layer;
wherein the functional layer comprises a first side, a second side and a stimuli-responsive polymer; wherein the stimuli-responsive polymer is a polymer selected from the group consisting of a poly(alkyl aldehyde), poly(halogenated aldehyde), poly(olefin sulfone), poly(cyanoacrylate), poly(glyoxylate), poly(glyoxamide), poly(isocyanate), poly(quinone methide), poly(benzyl ether), poly(carboxy pyrrole), poly(dithiothreoitol), poly(benzyl carbamate), copolymers thereof, cyclic polymers thereof, and combinations thereof.

2. The layered construction of claim 1,
wherein the stimuli-responsive polymer responds to at least one specific, non-ambient stimuli selected from the group consisting of base, acid, oxidizing agent, reducing agent, non-ionizing radiation, ultrasound, acid derived from a photoacid, ultraviolet light, infrared light, visible light, heat, and combinations thereof.

3. The layered construction of claim 1,
wherein at least one of,
(i) the poly(alkyl aldehyde) is a poly(alkyl aldehyde) derivative, and
(ii) the stimuli responsive polymer has at least one terminal alkene.

4. The layered construction of claim 3,
wherein the stimuli-responsive polymer is selected from the group consisting of a poly(glyoxamide) poly(glyoxylate)-poly(glyoxamide) copolymer, poly(glyoxylate), poly(alkyl aldehyde) derivative, and combinations thereof.

5. The layered construction of claim 3,
wherein the stimuli-responsive polymer is at least one of a poly(glyoxamide) and poly(glyoxamide)-poly(glyoxylate) copolymer having at least one terminal alkene.

6. The layered construction of claim 3,
wherein the stimuli-responsive having at least one terminal alkene is at least one of a poly(allyl glyoxamide) and a poly(allyl glyoxamide)-poly(glyoxylate) copolymer.

7. The layered construction of claim 1, further comprising:
a second layer comprising a first side and a second side;
wherein the second layer is applied to the first side of the functional layer; and
wherein the functional layer applied to the first side of the first layer.

8. The layered construction of claim 7,
wherein the first layer and the second layer have dissimilar compositions.

9. The layered construction of claim 7,
wherein the first layer is a base layer;
wherein the second layer is a release coating; and
wherein the stimuli-responsive polymer comprises the polymerized residues of Formula I: 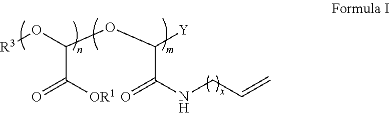
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
or a crosslinked derivative of Formula I.

10. The layered construction of claim 9, further including at least one additional functional layer.

11. The layered construction of claim 1, further comprising:
a second layer comprising a first side and a second side;
wherein the second layer is applied to the second side of the first layer; and
wherein the functional layer is located on the first side of the first layer;
wherein the first layer is an adhesive layer;
wherein the second layer is a facestock; and
wherein the stimuli-responsive polymer comprises the polymerized residues of Formula II: 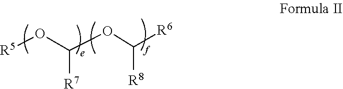
wherein:
e=1-1000 units;
f=0-1000 units;
g=1-15;
X=each, independently, O or NH;
R⁵=each, independently, H, (C₁-C₇)alkyl, allyl, 1-propynyl, 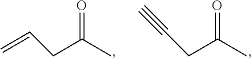
benzyl, triphenylmethyl, 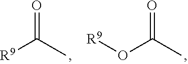
or R¹⁰ (wherein optionally at least one of R⁵ and R⁶=R¹⁰);
R⁶=each, independently, (C₁-C₈)alkyl, phenyl, benzyl, 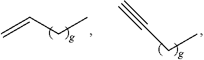
or —X—R¹¹; and
R⁷=each, independently, (C₁-C₂)alkyl, 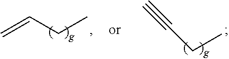
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁—C)alkyl, phenyl, benzyl, 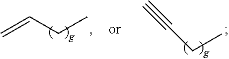
wherein e and f units form a random or block copolymer;
or a cyclic derivative or crosslinked derivative of Formula II.

12. The layered construction of claim 11,
wherein R¹⁰= 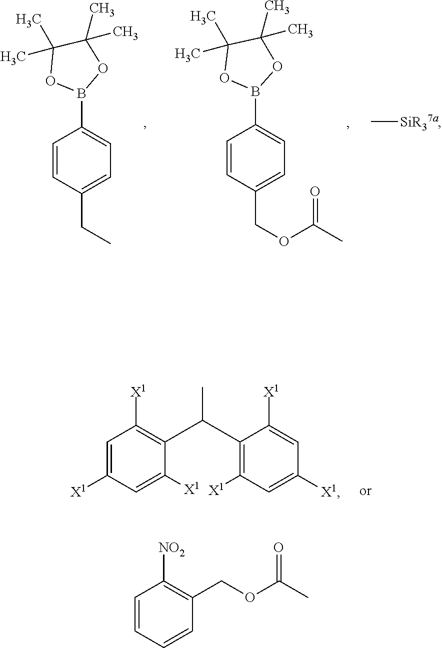
wherein:
R^{7a}=each, independently, (C₁-C₂₀)alkyl, phenyl, benzyl, 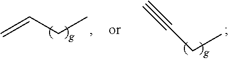
and
X¹=each, independently, H, (C₁-C₃)alkoxy, or NR^{7b}; and
R^{7b}=each, independently, (C₁-C₂)alkyl.

13. The layered construction of claim 11, wherein the adhesive layer is a functional adhesive layer comprising a stimuli-responsive polymer,
wherein the stimuli-responsive polymer comprises polymerized residues of Formula IIIA or Formula IIIB,
wherein Formula IIIA has a structure: 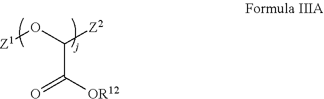
wherein:
h=1-15;
j=1-1000;
Z¹= 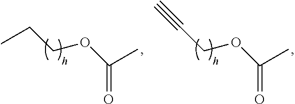
benzyl, triphenyl methyl, allyl, 1-propynyl, 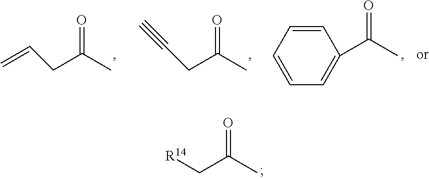
Z²=each, independently, (C₁-C₁₅)alkyl, (C₁-C₁₅)alkyoxy, 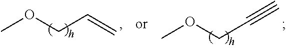
R¹²=each, independently, (C₁-C₇)alkyl;
R¹⁴=each, independently, (C₁-C₁₅)alkyl, phenyl, or benzyl;
or crosslinked derivative of Formula IIIA;
wherein Formula IIIB has a structure: 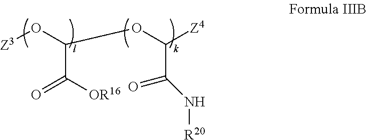
wherein:
k=1-1000 units;
l=0-1000 units;
p=each, independently, 1-15;
Z³= 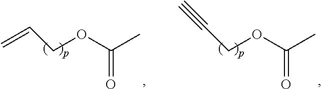
or R¹⁵;
Z⁴=methyl, —C(R¹⁹)₂—R¹⁷, or O—R⁷
R¹⁵=each, independently, (C₁-C₇)alkyl benzyl, triphenyl methyl, allyl, 1-propynyl, 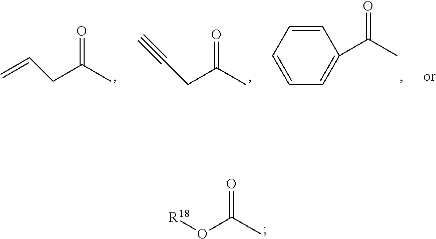
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, 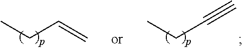
wherein k and l units form a random copolymer;
or crosslinked derivative of Formula IIIB.

14. The layered construction of claim 11, further including at least one additional functional layer.

15. The layered construction of claim 1,
wherein the first layer is a facestock;
wherein the functional layer is located on the first side of the first layer; and
wherein the stimuli-responsive polymer comprises the polymerized residues of Formula IIIA or Formula IIIB,
wherein Formula IIIA has a structure: 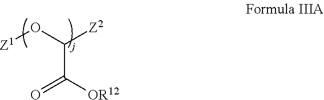
wherein:
h=1-15;
j=1-1000;
Z¹= 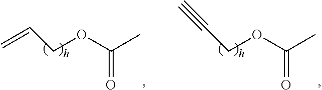
benzyl, triphenyl methyl, allyl, 1-propynyl, 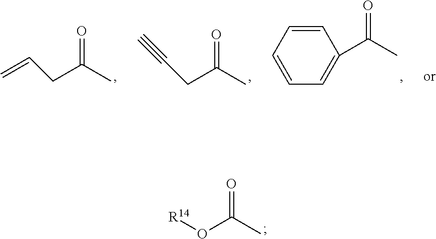
Z²=each, independently, (C₁-C₁₅)alkyl, (C₁-C₁₅)alkyoxy, 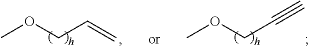
R¹²=each, independently, (C₁-C₇)alkyl;
R¹⁴=each, independently, (C₁-C₁₅)alkyl, phenyl, or benzyl;
or crosslinked derivative of Formula IIIA;
wherein Formula IIIB has a structure: 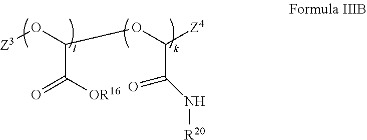
wherein:
k=1-1000 units;
l=0-1000 units;
p=each, independently, 1-15;
Z³= 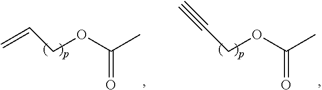
or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl, 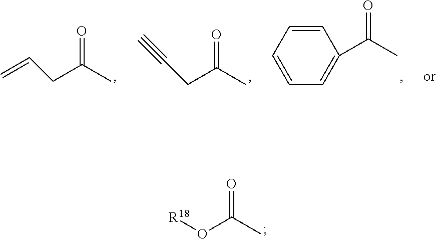
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, 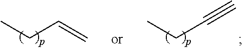
wherein k and l units form a random copolymer;
or crosslinked derivative of Formula IIIB.

16. The layered construction of claim 15, further including at least one additional functional layer.

17. The layered construction of claim 16, wherein at least one of the additional functional layers is a masking layer.

18. The layered construction of claim 15,
wherein the functional layer further comprises a second polymer.

19. The layered construction of claim 1,
wherein the first layer is a facestock;
wherein the functional layer is a printable top coat; and
wherein the stimuli-responsive polymer comprises the polymerized residues of Formula I: 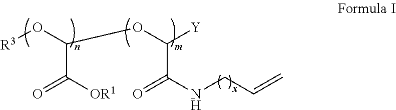
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
or a crosslinked derivative of Formula I.

20. The layered construction of claim 1,
wherein the first layer is a facestock;
wherein the functional layer comprises an ink; and
wherein the stimuli-responsive polymer comprises the polymerized residues of at least one of Formula I, a crosslinked derivative of Formula I, Formula II, a cyclic derivative of Formula II, a crosslinked derivative Formula II, Formula IIIA, a crosslinked derivative of Formula IIIA, a crosslinked derivative of Formula IIIA, Formula IIIB, and a crosslinked derivative of Formula IIIB,
wherein Formula I has a structure: 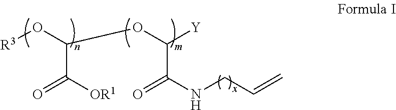
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure: 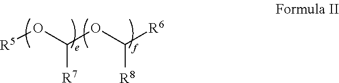
wherein:
e=1-1000 units;
f=0-1000 units;
g=1-15;
X=each, independently, O or S;
R⁵=each, independently, H, (C₁—C)alkyl, allyl, 1-propynyl, 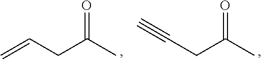
benzyl, triphenylmethyl, 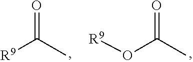
or R¹⁰ (wherein optionally at least one of R⁵ and R⁶=R¹⁰);
R⁶=each, independently, (C₁-C₈)alkyl, phenyl, benzyl, 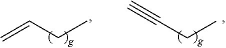
or —X—R¹¹; and
R⁷=each, independently, (C₁-C₂₀)alkyl, 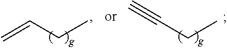
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl, 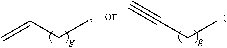
wherein e and f units form a random or block copolymer;
wherein Formula IIIA has a structure: 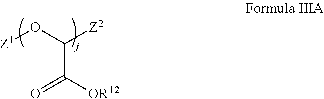
wherein:
h=1-15;
j=1-1000;
Z¹= 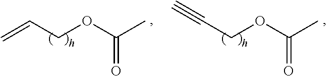
benzyl, triphenyl methyl, allyl, 1-propynyl, 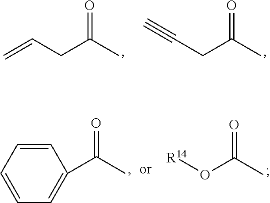
Z²=each independently, (C₁-C₁₅)alkyl, (C₁-C₁₅)alkyoxy, 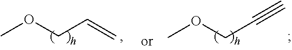
R¹²=each, independently, (C₁-C₇)alkyl;
R¹⁴=each, independently, (C₁-C₁₅)alkyl, phenyl, or benzyl; and
wherein Formula IIIB has a structure: 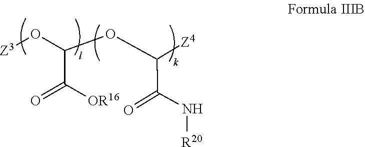
wherein:
k=1-1000 units;
l=0-1000 units;
p=each, independently, 1-15;
Z³= 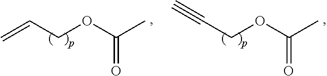
or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl, 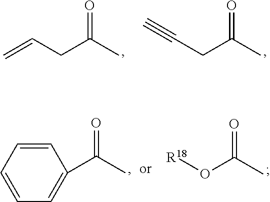
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, 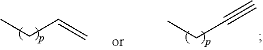
wherein k and l units form a random copolymer.

21. The layered construction of claim 20,
wherein R¹⁰= 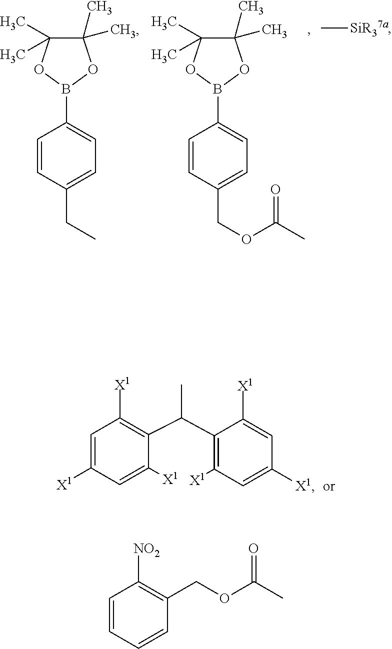
wherein:
R^{7a}=each, independently, (C₁-C₂₀)alkyl, phenyl, benzyl, 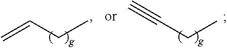
and
X¹=each, independently, H, (C₁-C₃)alkoxy, or NR^{7b}; and
R^{7b}=each, independently, (C₁-C₂)alkyl.

22. The layered construction of claim 20, wherein the ink is in the form of a printed indicia.

23. The layered construction of claim 20, further including at least one additional functional layer.

24. The layered construction of claim 10, wherein the at least one additional functional layer comprises at least one stimuli-responsive polymer;
wherein at least one of the stimuli-responsive polymer functional layer comprises polymerized residues selected from the group consisting of Formula I or a crosslinked derivative thereof, Formula II or a cyclic derivative or crosslinked derivative, Formula IIIA or a crosslinked derivative thereof, or Formula IIIB or a crosslinked derivative thereof;
wherein Formula I has a structure: 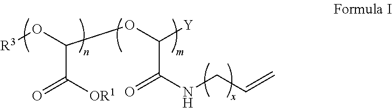
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure: 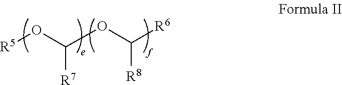
wherein:
e=1-1000 units;
f=0-1000 units;
g=1-15;
X=each, independently, O or NH;
R⁵=each, independently, H, (C₁-C₇)alkyl, allyl, 1-propynyl, 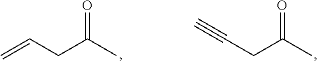
benzyl, triphenylmethyl, 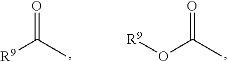
or R¹⁰ (wherein optionally at least one of R⁵ and R⁶=R¹⁰);
R⁶=each, independently, (C₁-C₈)alkyl, phenyl, benzyl, 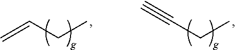
or —X—R¹¹; and
R⁷=each, independently, (C₁-C₂₀)alkyl, 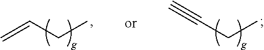
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl, 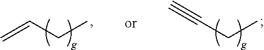
and
wherein e and f units form a random or block copolymer;
wherein Formula IIIA has a structure: 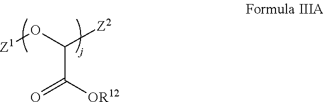
wherein:
h=1-15;
j=1-1000;
Z¹= 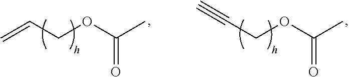
benzyl, triphenyl methyl, allyl, 1-propynyl, 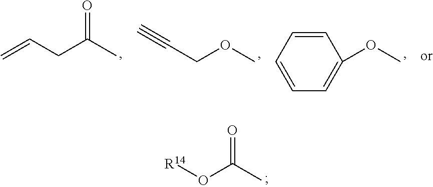
Z²=each, independently, (C₁-C₁₅)alkyl, (C₁-C₁₅)alkyoxy, 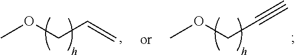
R¹²=each, independently, (C₁-C₇)alkyl;
R¹⁴=each, independently, (C₁-C₁₅)alkyl, phenyl, or benzyl; and
wherein Formula IIIB has a structure: 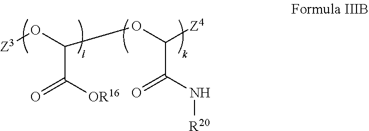
wherein:
k=1-1000 units;
l=0-1000 units;
p=each, independently, 1-15;
Z³= 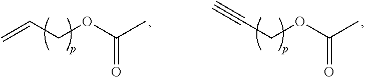
or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl, 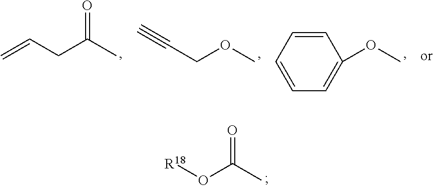
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, 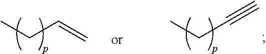
wherein k and l units form a random copolymer.

25. A method of recycling a coated release liner, comprising:
providing the layered construction of claim 7;
wherein the first layer is a base layer; and
wherein the second layer is a release coating; and
exposing the layered construction to a non-ambient stimulus for a time sufficient to separate the first layer from the second layer.

26. The method of recycling a coated release liner of claim 25,
wherein the non-ambient stimulus is at least one material selected from the group consisting of a base, acid, oxidizing agent, reducing agent, non-ionizing radiation, ultrasound, acid derived from a photoacid, ultraviolet light, infrared light, visible light, heat, and combinations thereof.

27. A method of providing a linerless adhesive article, comprising:
providing the layered construction of claim 11;
wherein the first layer is an adhesive layer; and
wherein the second layer is a facestock; and
exposing the layered construction to a non-ambient stimulus for a time sufficient to remove the functional layer from the first layer to reveal the adhesive layer.

28. The method of claim 27,
wherein the adhesive layer comprises a stimuli-responsive polymer; and
wherein the layered construction is exposed to a non-ambient stimulus for a time sufficient to remove the first layer from the second layer.

29. The method of claim 27,
wherein the non-ambient stimulus is at least one material selected from the group consisting of a base, acid, oxidizing agent, reducing agent, non-ionizing radiation, ultrasound, acid derived from a photoacid, ultraviolet light, infrared light, visible light, heat, and combinations thereof.

30. A method of recycling, composting, and/or providing a degradable adhesive article, comprising:
providing the layered construction of claim 1;
wherein the first layer is a facestock layer; and
wherein the functional layer functions as a pressure sensitive adhesive; and
exposing the layered construction to a non-ambient stimulus for a time sufficient to depolymerize the functional layer.

31. The method of claim 30,
wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

32. A method of recycling a printed facestock, comprising:
providing the layered construction of claim 1;
wherein the first layer is a facestock layer;
wherein the functional layer is a printable top coat; and
wherein the layered construction further comprises printed indicia on the top coat; and
exposing the layered construction to a non-ambient stimulus for a time sufficient to depolymerize the functional layer.

33. The method of claim 32,
wherein the non-ambient stimulus is at least one material selected from the group consisting of a base, acid, oxidizing agent, reducing agent, non-ionizing radiation, ultrasound, acid derived from a photoacid, ultraviolet light, infrared light, visible light, heat, and combinations thereof.

34. A method of recycling a printed facestock, comprising:
providing the layered construction of claim 1;
wherein the first layer is a facestock;
wherein the functional layer is an ink; and
exposing the layered construction to a non-ambient stimulus for a time sufficient to depolymerize the functional layer.

35. The method of claim 34,
wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

36. The layered construction claim 14, wherein the at least one additional functional layer comprises at least one stimuli-responsive polymer;
wherein at least one of the stimuli-responsive polymer functional layer comprises polymerized residues selected from the group consisting of Formula I or a crosslinked derivative thereof, Formula II or a cyclic derivative or crosslinked derivative, Formula IIIA or a crosslinked derivative thereof, or Formula IIIB or a crosslinked derivative thereof;
wherein Formula I has a structure: 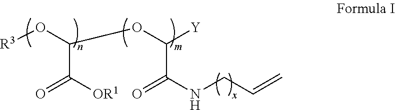
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure: 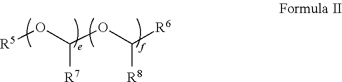
wherein:
e=1-1000 units;
f=0-1000 units;
g=1-15;
X=each, independently, O or NH;
R⁵=each, independently, H, (C₁-C₇)alkyl, allyl, 1-propynyl, 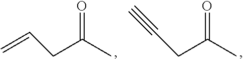
benzyl, triphenylmethyl, 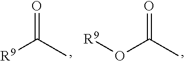
or R¹⁰ (wherein optionally at least one of R⁵ and R⁶=R¹⁰);
R⁶=each, independently, (C₁-C₈)alkyl, phenyl, benzyl, 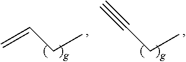
or —X—R¹¹; and
R⁷=each, independently, (C₁-C₂₀)alkyl, 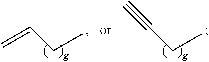
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁—C)alkyl, phenyl, benzyl, 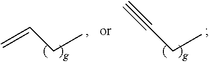
and
wherein e and f units form a random or block copolymer;
wherein Formula IIIA has a structure: 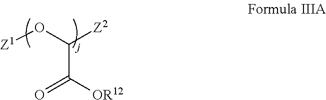
wherein:
h=1-15;
j=1-1000;
Z¹= 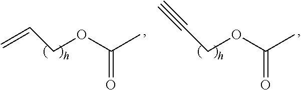
benzyl, triphenyl methyl, allyl, 1-propynyl, 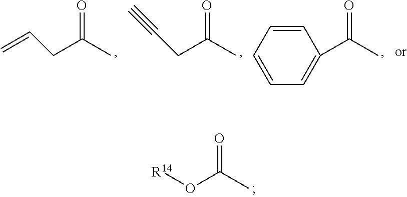
Z²=each, independently, (C₁-C₁₅)alkyl, (C₁-C₁₅)alkyoxy, 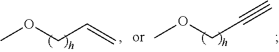
R¹²=each, independently, (C₁-C₇)alkyl;
R¹⁴=each, independently, (C₁-C₁₅)alkyl, phenyl, or benzyl; and
wherein Formula IIIB has a structure: 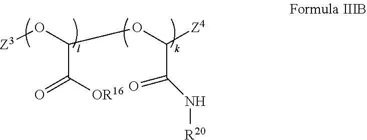
wherein:
k=1-1000 units;
l=0-1000 units;
p=each, independently, 1-15;
Z³= 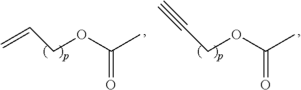
or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl, 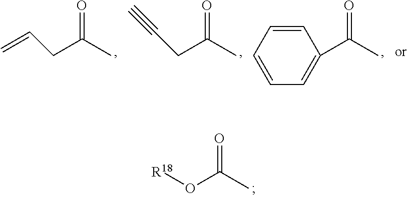
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl;
R²⁰=each, independently, 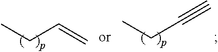
wherein k and l units form a random copolymer.

37. The layered construction claim 16, wherein the at least one additional functional layer comprises at least one stimuli-responsive polymer;
wherein at least one of the stimuli-responsive polymer functional layer comprises polymerized residues selected from the group consisting of Formula I or a crosslinked derivative thereof, Formula II or a cyclic derivative or crosslinked derivative, Formula IIIA or a crosslinked derivative thereof, or Formula IIIB or a crosslinked derivative thereof;
wherein Formula I has a structure: 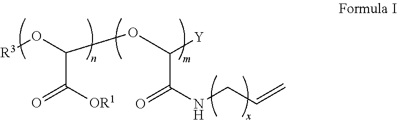
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure: 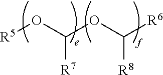
wherein:
e=1-1000 units;
f=0-1000 units;
g=1-15;
X=each, independently, O or NH;
R⁶=each, independently, H, (C₁-C₇)alkyl, allyl, 1-propynyl, 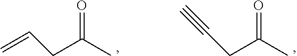
benzyl, triphenylmethyl, 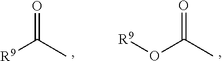
or R¹⁰ (wherein optionally at least one of R⁵ and R⁶=R¹⁰);
R⁶=each, independently, (C₁-C₈)alkyl, phenyl, benzyl, 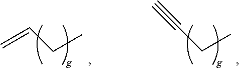
or —X—R¹¹; and
R⁷=each, independently, (C₁-C₂₀)alkyl, 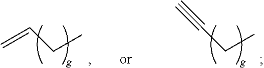
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl, 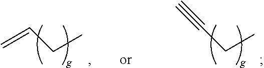
and
wherein e and f units form a random or block copolymer;
wherein Formula IIIA has a structure: 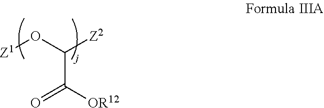
Wherein:
h=1-15;
j=1-1000;
Z¹= 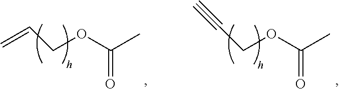
benzyl, triphenyl methyl, allyl, 1-propynyl, 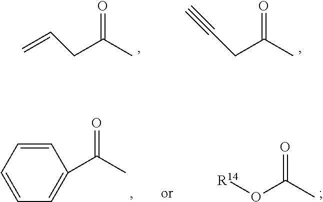
Z²=each, independently, (C₁-C₁₅)alkyl, (C₁-C₁₅)alkyoxy, 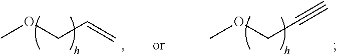
R¹²=each, independently, (C₁-C₇)alkyl;
R¹⁴=each, independently, (C₁-C₁₅)alkyl, phenyl, or benzyl; and
wherein Formula IIIB has a structure: 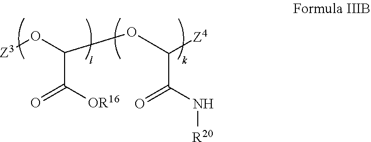
wherein:
k=1-1000 units;
l=0-1000 units;
p=each, independently, 1-15;
Z³= 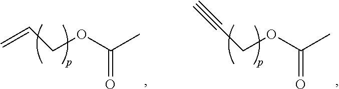
or R¹⁵;
Z⁴=methyl, —C(R¹⁹)₂—R¹⁷, or O—R⁷
R¹⁵=each, independently, (C₁-C₇)alkyl benzyl, triphenyl methyl, allyl, 1-propynyl, 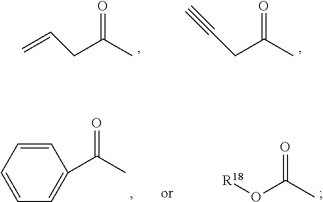
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl; 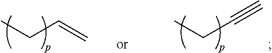
R²⁰=each, independently, or
wherein k and l units form a random copolymer.

38. The layered construction claim 23, wherein the at least one additional functional layer comprises at least one stimuli-responsive polymer;
wherein at least one of the stimuli-responsive polymer functional layer comprises polymerized residues selected from the group consisting of Formula I or a crosslinked derivative thereof, Formula II or a cyclic derivative or crosslinked derivative, Formula IIIA or a crosslinked derivative thereof, or Formula IIIB or a crosslinked derivative thereof;
wherein Formula I has a structure: 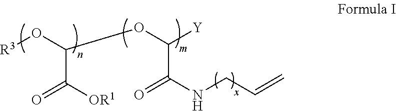
wherein:
m=0-1000 units;
n=0-1000 units;
x=1-15;
Y=—CH₃, —CH₂R², —CH(R²)₂, —CH(R²)₃, or —OR²;
R¹=each, independently, H, (C₁-C₈)alkyl, allyl, alkynyl, furfuryl, or N-methylmaleimide;
R²=each, independently, H, (C₁-C₈)alkyl or allyl; and
R³=methyl, allyl, 1-propynyl, benzyl, triphenyl methyl, or triphenylacetoxy;
wherein the m and n units form a random copolymer;
wherein Formula II has a structure: 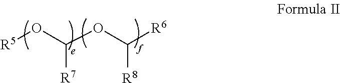
wherein:
e=1-1000 units;
f=0-1000 units;
g=1-15;
X=each, independently, O or NH;
R⁶=each, independently, H, (C₁-C₇)alkyl, allyl, 1-propynyl, 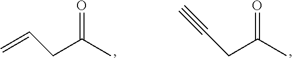
benzyl, triphenylmethyl, 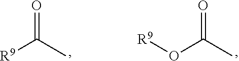
or R¹⁰ (wherein optionally at least one of R⁵ and R⁶=R¹⁰);
R⁶=each, independently, (C₁-C₈)alkyl, phenyl, benzyl, 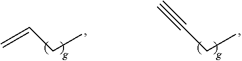
or —X—R¹¹; and
R⁷=each, independently, (C₁-C₂₀)alkyl, 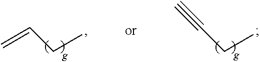
R⁸=each, independently, (C₁-C₁₅)alkyl, phenyl, benzyl, allyl, or 1-propynyl;
R⁹=each, independently, (C₁-C₁₅)alkyl, phenyl, benzyl, allyl, or 1-propynyl;
R¹⁰=detection unit that cleaves in response to a specific applied stimulus; and
R¹¹=each, independently, (C₁-C₇)alkyl, phenyl, benzyl, 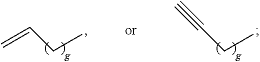
and
wherein e and f units form a random or block copolymer;
wherein Formula IIIA has a structure: 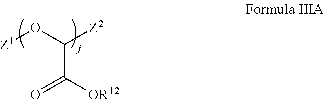
wherein:
h=1-15;
j=1-1000;
Z¹= 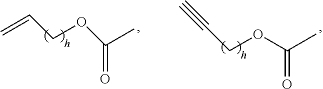
benzyl, triphenyl methyl, allyl, 1-propynyl, 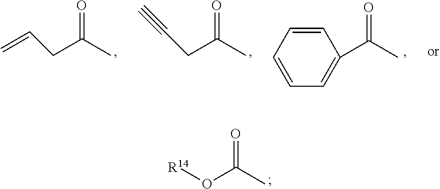
Z²=each, independently, (C₁-C₁₅)alkyl, (C₁-C₁₅)alkyoxy, 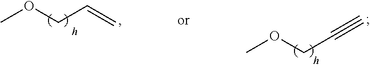
R¹²=each, independently, (C₁-C₇)alkyl;
R¹⁴=each, independently, (C₁-C₁₅)alkyl, phenyl, or benzyl; and
wherein Formula IIIB has a structure: 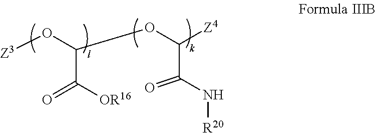
wherein:
k=1-1000 units;
l=0-1000 units;
p=each, independently, 1-15;
Z³= 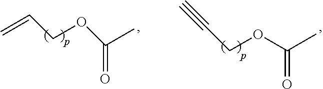
or R¹⁵;
Z⁴=methyl, —C(R¹⁹)₂—R¹⁷, or O—R¹⁷;
R¹⁵=each, independently, (C₁-C₇)alkyl benzyl, triphenyl methyl, allyl, 1-propynyl, 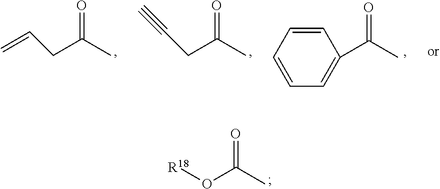
R¹⁶=each, independently, (C₁-C₈)alkyl;
R¹⁷=each, independently, (C₁-C₈)alkyl;
R¹⁸=each, independently, (C₁-C₁₅)alkyl, phenyl, or benzyl;
R¹⁹=each, independently, H or (C₁-C₈)alkyl; 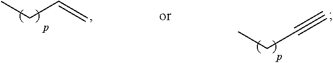
R²⁰=each, independently, or
wherein k and l units form a random copolymer.

39. A method of recycling, composting, and/or providing a degradable adhesive article, comprising:
providing the layered construction of claim 15;
wherein the first layer is a facestock layer; and
wherein the functional layer functions as a pressure sensitive adhesive; and
exposing the layered construction to a non-ambient stimulus for a time sufficient to depolymerize the functional layer.

40. The method of claim 39,
wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

41. A method of recycling a printed facestock, comprising:
providing the layered construction of claim 9;
wherein the first layer is a facestock layer;
wherein the functional layer is a printable top coat; and
wherein the layered construction further comprises printed indicia on the top coat; and
exposing the layered construction to a non-ambient stimulus for a time sufficient to depolymerize the functional layer.

42. The method of claim 41,
wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.

43. A method of recycling a printed facestock, comprising:
providing the layered construction of claim 20;
wherein the first layer is a facestock;
wherein the functional layer is an ink; and
exposing the layered construction to a non-ambient stimulus for a time sufficient to depolymerize the functional layer.

44. The method of claim 43,
wherein the non-ambient stimulus is at least one material selected from the group consisting of base, acid, oxidizing agent, reducing agent, non-ionizing radiation, ultrasound, acid derived from a photoacid, ultraviolet light, infrared light, visible light, heat, and combinations thereof.
